(19) United States
(12) Patent Application Publication
(10) Pub. No.: US 2024/0430048 A1
(43) Pub. Date: Dec. 26, 2024

(54) RESOURCE POOLS WITH REFERENCE SIGNAL RESOURCES

(71) Applicant: QUALCOMM INCORPORATED, San Diego, CA (US)

(72) Inventors: Alexandros MANOLAKOS, Athens (GR); Weimin DUAN, San Diego, CA (US); Seyedkianoush HOSSEINI, San Diego, CA (US)

(21) Appl. No.: 18/686,119

(22) PCT Filed: Sep. 28, 2022
(86) PCT No.: PCT/US2022/045070

§ 371 Date: Feb. 23, 2024

(30) Foreign Application Priority Data
Oct. 29, 2021 (GR) 20210100749

(51) Int. Cl. H04L 5/00; H04W 72/25

(52) U.S. Cl. CPC H04L 5/0007; H04L 5/0094; H04W 72/25

(57) ABSTRACT

A reference signal receiving method includes: obtaining, at a user equipment, a sidelink resource pool configuration including configuration parameters of one or more SL OFDM resources (sidelink orthogonal frequency division multiplexing resources) including one or more SL OFDM RS resources (SL OFDM reference signal resources) each dedicated to carrying one or more sidelink reference signals; receiving, at the user equipment, reference signal control information indicating a first resource location of at least one of the one or more SL OFDM RS resources; decoding, at the user equipment, the reference signal control information; and using, at the user equipment, the at least one of the one or more SL OFDM RS resources to receive a first reference signal.

### CROSS-REFERENCE TO RELATED APPLICATIONS

This application claims the benefit of Greek patent application Ser. No. 20210100749, filed Oct. 29, 2021, entitled “RESOURCE POOLS WITH REFERENCE SIGNAL RESOURCES,” which is assigned to the assignee hereof, and the entire contents of which are hereby incorporated herein by reference for all purposes.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax), a fifth-generation (5G) service, etc. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Orthogonal Frequency Division Multiple Access (OFDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

In 5G New Radio (NR), a sidelink bandwidth part (SL-BWP) may be configured to contain multiple pools of Orthogonal Frequency Division Multiplexing (OFDM) resources. One BWP may contain multiple receiving and transmitting resource pools. Physical layer channels may be configured per resource pool.

### SUMMARY

An example user equipment includes: a transceiver; a memory; and a processor, communicatively coupled to the memory and the transceiver, that is: configured to obtain a sidelink resource pool configuration including configuration parameters of one or more SL OFDM resources (sidelink orthogonal frequency division multiplexing resources) including one or more SL OFDM RS resources (SL OFDM reference signal resources) each dedicated to carrying one or more sidelink reference signals; configured to receive, via the transceiver, reference signal control information indicating a first resource location of at least one of the one or more SL OFDM RS resources; configured to decode the reference signal control information; and configured to use the at least one of the one or more SL OFDM RS resources to receive a first reference signal via the transceiver.

An example reference signal receiving method includes: obtaining, at a user equipment, a sidelink resource pool configuration including configuration parameters of one or more SL OFDM resources (sidelink orthogonal frequency division multiplexing resources) including one or more SL OFDM RS resources (SL OFDM reference signal resources) each dedicated to carrying one or more sidelink reference signals; receiving, at the user equipment, reference signal control information indicating a first resource location of at least one of the one or more SL OFDM RS resources; decoding, at the user equipment, the reference signal control information; and using, at the user equipment, the at least one of the one or more SL OFDM RS resources to receive a first reference signal.

Another example user equipment includes: means for obtaining a sidelink resource pool configuration including configuration parameters of one or more SL OFDM resources (sidelink orthogonal frequency division multiplexing resources) including one or more SL OFDM RS resources (SL OFDM reference signal resources) each dedicated to carrying one or more sidelink reference signals; means for receiving reference signal control information indicating a first resource location of at least one of the one or more SL OFDM RS resources; means for decoding the reference signal control information; and means for using the at least one of the one or more SL OFDM RS resources to receive a first reference signal.

An example non-transitory, processor-readable storage medium includes processor-readable instructions to cause a processor of a user equipment to: obtain a sidelink resource pool configuration including configuration parameters of one or more SL OFDM resources (sidelink orthogonal frequency division multiplexing resources) including one or more SL OFDM RS resources (SL OFDM reference signal resources) each dedicated to carrying one or more sidelink reference signals; receive reference signal control information indicating a first resource location of at least one of the one or more SL OFDM RS resources; decode the reference signal control information; and use the at least one of the one or more SL OFDM RS resources to receive a first reference signal.

An example apparatus includes: a transceiver; a memory; and a processor, communicatively coupled to the memory and the transceiver, configured to: obtain a sidelink resource pool configuration including first configuration parameters, of one or more SL OFDM data resources (sidelink orthogonal frequency division multiplexing data resources) each dedicated to carrying data or communication information, and second configuration parameters, of one or more SL OFDM RS resources (SL OFDM reference signal resources) each dedicated to carrying one or more sidelink reference signals; and transmit, via the transceiver, the sidelink resource pool configuration.

An example resource pool allocation method includes: obtaining, at an apparatus, a sidelink resource pool configuration including first configuration parameters, of one or more SL OFDM data resources (sidelink orthogonal frequency division multiplexing data resources) each dedicated to carrying data or communication information, and second configuration parameters, of one or more SL OFDM RS resources (SL OFDM reference signal resources) each dedicated to carrying one or more sidelink reference signals; and transmitting, from the apparatus to a user equipment, the sidelink resource pool configuration.

Another example apparatus includes: means for obtaining a sidelink resource pool configuration including first configuration parameters, of one or more SL OFDM data resources (sidelink orthogonal frequency division multiplexing data resources) each dedicated to carrying data or communication information, and second configuration parameters, of one or more SL OFDM RS resources (SL OFDM reference signal resources) each dedicated to carrying one or more sidelink reference signals; and means for transmitting, to a user equipment, the sidelink resource pool configuration.

Another example non-transitory, processor-readable storage medium includes processor-readable instructions to cause a processor of an apparatus to: obtain a sidelink resource pool configuration including first configuration parameters, of one or more SL OFDM data resources (sidelink orthogonal frequency division multiplexing data resources) each dedicated to carrying data or communication information, and second configuration parameters, of one or more SL OFDM RS resources (SL OFDM reference signal resources) each dedicated to carrying one or more sidelink reference signals; and

transmit, to a user equipment, the sidelink resource pool configuration.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3 is a block diagram of components of an example transmission/reception point.

FIG. 4 is a block diagram of components of an example server, various embodiments of which are shown in FIG. 1.

FIG. 5 is a block diagram of an example user equipment.

FIG. 6 is a block diagram of an example network entity.

FIG. 7 is a simplified diagram of mode 1 operation of sidelink communication.

FIG. 8 is a simplified diagram of mode 2 operation of sidelink communication.

FIG. 9 is a sidelink reference pool configuration.

FIG. 10 is a block diagram of sidelink configuration/pre-configuration including resource pools for conveying both data and reference signals.

FIG. 11 is a timing diagram of two-stage control information and reference signal transmission.

FIG. 12 is a block diagram of a legacy first-stage control information format.

FIG. 13 is a block diagram of sidelink configuration/pre-configuration including separate resource pools for conveying data and reference signals.

FIG. 14 is a timing diagram of two-stage control information and reference signal transmission in resources of a resource pool dedicated to reference signal transmission.

FIG. 15 is a block diagram of a slot containing second-stage control information and reference signals.

FIG. 16 is a block diagram of a first-stage control information format including sidelink reference signal configuration information.

FIG. 17 is a timing diagram of single-stage control information and reference signal transmission in resources of a resource pool dedicated to reference signal transmission.

FIG. 18 is a block diagram of single-stage control information pointing to a reference signal is a slot containing reference signals.

FIG. 19, is a signaling and process flow for using resource pools to transmit and receive reference signals.

FIG. 20 shows a simplified example of data resource pool configuration parameters and a simplified example of reference signal resource pool configuration parameters.

FIG. 21 is a block flow diagram of a reference signal receiving method.

FIG. 22 is a block flow diagram of a resource pool allocation method.

### DETAILED DESCRIPTION

Techniques are discussed herein for establishing, disseminating, and using resource pools that include resources for transmitting and receiving (e.g., measuring) reference signals. For example, a resource pool is scheduled with resources for data (including communication) and for one or more reference signals. Two-stage control information can be included with first stage control information being in a format that does not include reference signal configuration information and that directs a recipient to second stage control information that directs the recipient to a reference signal resource location. As another example, a resource pool for data and a separate resource pool for one or more reference signals may be established and disseminated. Two-stage control information can be included with first stage control information being in a format that does not include reference signal configuration information and that directs a recipient to second stage control information that directs the recipient to the reference signal resource location. Alternatively, the first stage control information may be in a new format that includes reference signal configuration information. As another alternative, signal-stage control information may be provided in a new format that directs the recipient to the reference signal resource location. These implementations are examples, and other implementations may be used.

Items and/or techniques described herein may provide one or more of the following capabilities, as well as other capabilities not mentioned. Reference signal measurement accuracy may be improved. Positioning accuracy may be improved, e.g., due to improved measurement accuracy of positioning reference signals. Channel state may be more accurately determined, e.g., due to improved measurement accuracy of a channel state information reference signal. Other capabilities may be provided and not every implementation according to the disclosure must provide any, let alone all, of the capabilities discussed.

Obtaining the locations of mobile devices that are accessing a wireless network may be useful for many applications including, for example, emergency calls, personal navigation, consumer asset tracking, locating a friend or family member, etc. Existing positioning methods include methods based on measuring radio signals transmitted from a variety of devices or entities including satellite vehicles (SVs) and terrestrial radio sources in a wireless network such as base stations and access points. It is expected that standardization for the 5G wireless networks will include support for various positioning methods, which may utilize reference signals transmitted by base stations in a manner similar to which LTE wireless networks currently utilize Positioning Reference Signals (PRS) and/or Cell-specific Reference Signals (CRS) for position determination.

The description herein may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various examples described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, such UEs may be any wireless communication device (e.g., a mobile phone, router, tablet computer, laptop computer, consumer asset tracking device, Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi networks (e.g., based on IEEE (Institute of Electrical and Electronics Engineers) 802.11, etc.) and so on.

A base station may operate according to one of several RATs in communication with UEs depending on the network in which it is deployed. Examples of a base station include an Access Point (AP), a Network Node, a NodeB, an evolved NodeB (eNB), or a general Node B (gNodeB, gNB). In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

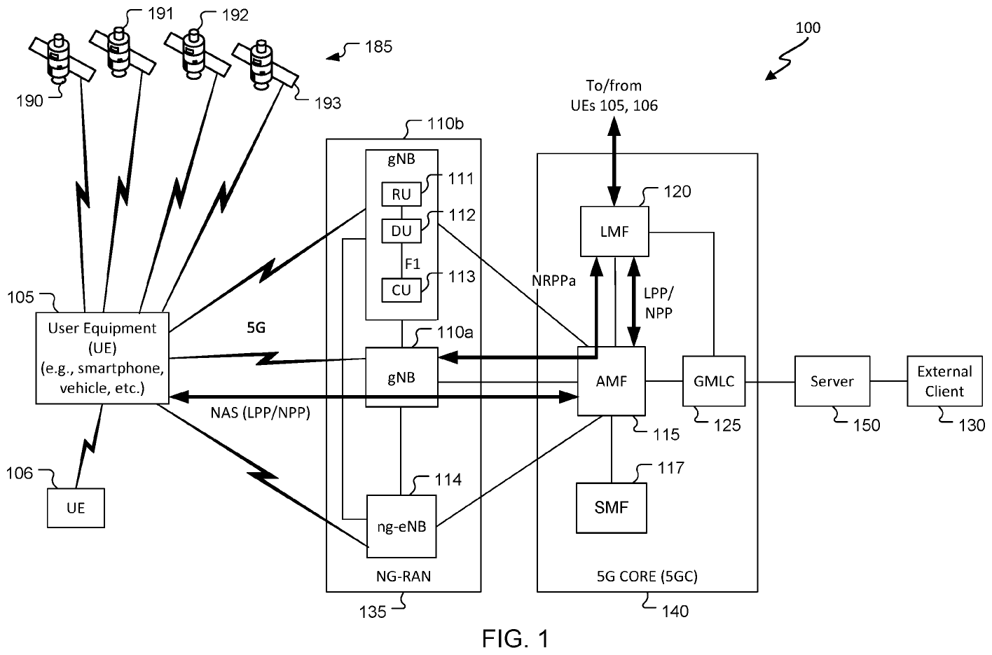

Referring to FIG. 1, an example of a communication system 100 includes a UE 105, a UE 106, a Radio Access Network (RAN), here a Fifth Generation (5G) Next Generation (NG) RAN (NG-RAN) 135, a 5G Core Network (5GC) 140, and a server 150. The UE 105 and/or the UE 106 may be, e.g., an IoT device, a location tracker device, a cellular telephone, a vehicle (e.g., a car, a truck, a bus, a boat, etc.), or other device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3rd Generation Partnership Project (3GPP). Accordingly, the NG-RAN 135 and the 5GC 140 may conform to current or future standards for 5G support from 3GPP. The NG-RAN 135 may be another type of RAN, e.g., a 3G RAN, a 4G Long Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. Base stations such as the gNBs 110a, 110b and/or the ng-eNB 114 may be a macro cell (e.g., a high-power cellular base station), or a small cell (e.g., a low-power cellular base station), or an access point (e.g., a short-range base station configured to communicate with short-range technology such as WiFi, WiFi-Direct (WiFi-D), Bluetooth®, Bluetooth®-low energy (BLE), Zigbee, etc. One or more base stations, e.g., one or more of the gNBs 110a, 110b and/or the ng-eNB 114 may be configured to communicate with the UE 105 via multiple carriers. Each of the gNBs 110a, 110b and/or the ng-eNB 114 may provide communication coverage for a respective geographic region, e.g., a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114. AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a. 110b are examples and may, in various embodiments, be replaced by or include various other location server functionality and/or base station functionality respectively.

The system 100 is capable of wireless communication in that components of the system 100 can communicate with one another (at least some times using wireless connections) directly or indirectly, e.g., via the gNBs 110a, 110b, the ng-eNB 114, and/or the 5GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the gNBs 110a, 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi communication, multiple frequencies of Wi-Fi communication, satellite positioning, one or more types of communications (e.g., GSM (Global System for Mobiles), CDMA (Code Division Multiple Access), LTE (Long Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH).

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi (also referred to as Wi-Fi), Bluetooth® (BT), Worldwide Interoperability for Microwave Access (WiMAX), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi Direct (WiFi-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g., the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may comprise a TRP, although multiple TRPs may share one or more components (e.g., share a processor but have separate antennas). The system 100 may include macro TRPs exclusively or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

Each of the gNBs 110a, 110b and/or the ng-eNB 114 may include a radio unit (RU), a distributed unit (DU), and a central unit (CU). For example, the gNB 110b includes an RU 111, a DU 112, and a CU 113. The RU 111, DU 112, and CU 113 divide functionality of the gNB 110b. While the gNB 110b is shown with a single RU, a single DU, and a single CU, a gNB may include one or more RUs, one or more DUs, and/or one or more CUs. An interface between the CU 113 and the DU 112 is referred to as an F1 interface. The RU 111 is configured to perform digital front end (DFE) functions (e.g., analog-to-digital conversion, filtering, power amplification, transmission/reception) and digital beamforming, and includes a portion of the physical (PHY) layer. The RU 111 may perform the DFE using massive multiple input/multiple output (MIMO) and may be integrated with one or more antennas of the gNB 110b. The DU 112 hosts the Radio Link Control (RLC), Medium Access Control (MAC), and physical layers of the gNB 110b. One DU can support one or more cells, and each cell is supported by a single DU. The operation of the DU 112 is controlled by the CU 113. The CU 113 is configured to perform functions for transferring user data, mobility control, radio access network sharing, positioning, session management, etc. although some functions are allocated exclusively to the DU 112. The CU 113 hosts the Radio Resource Control (RRC), Service Data Adaptation Protocol (SDAP), and Packet Data Convergence Protocol (PDCP) protocols of the gNB 110b. The UE 105 may communicate with the CU 113 via RRC, SDAP, and PDCP layers, with the DU 112 via the RLC, MAC, and PHY layers, and with the RU 111 via the PHY layer.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT. Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g., by the LMF 120). The AMF 115 may serve as a control node that processes signaling between the UE 105 and the 5GC 140, and may provide QoS (Quality of Service) flow and session management. The AMF 115 may support mobility of the UE 105 including cell change and handover and may participate in supporting signaling connection to the UE 105.

The server 150, e.g., a cloud server, is configured to obtain and provide location estimates of the UE 105 to the external client 130. The server 150 may, for example, be configured to run a microservice/service that obtains the location estimate of the UE 105. The server 150 may, for example, pull the location estimate from (e.g., by sending a location request to) the UE 105, one or more of the gNBs 110a, 110b (e.g., via the RU 111, the DU 112, and the CU 113) and/or the ng-eNB 114, and/or the LMF 120. As another example, the UE 105, one or more of the gNBs 110a, 110b (e.g., via the RU 111, the DU 112, and the CU 113), and/or the LMF 120 may push the location estimate of the UE 105 to the server 150.

The GMLC 125 may support a location request for the UE 105 received from the external client 130 via the server 150 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130 via the server 150. The GMLC 125 is shown connected to both the AMF 115 and LMF 120, though may not be connected to the AMF 115 or the LMF 120 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS or PRS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS or PRS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such embodiments, the 5GC 140 may be configured to control different air interfaces. For example, the 5GC 140 may be connected to a WLAN using a Non-3GPP InterWorking Function (N3IWF, not shown FIG. 1) in the 5GC 140. For example, the WLAN may support IEEE 802.11 WiFi access for the UE 105 and may comprise one or more WiFi APs. Here, the N3IWF may connect to the WLAN and to other elements in the 5GC 140 such as the AMF 115. In some embodiments, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other embodiments, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi APs, an MME, and an E-SMLC.

As noted, in some embodiments, positioning functionality may be implemented, at least in part, using the directional SS or PRS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS or PRS beams from a plurality of base stations (such as the gNBs 110a, 110b, the ng-eNB 114, etc.) to compute the UE's position.

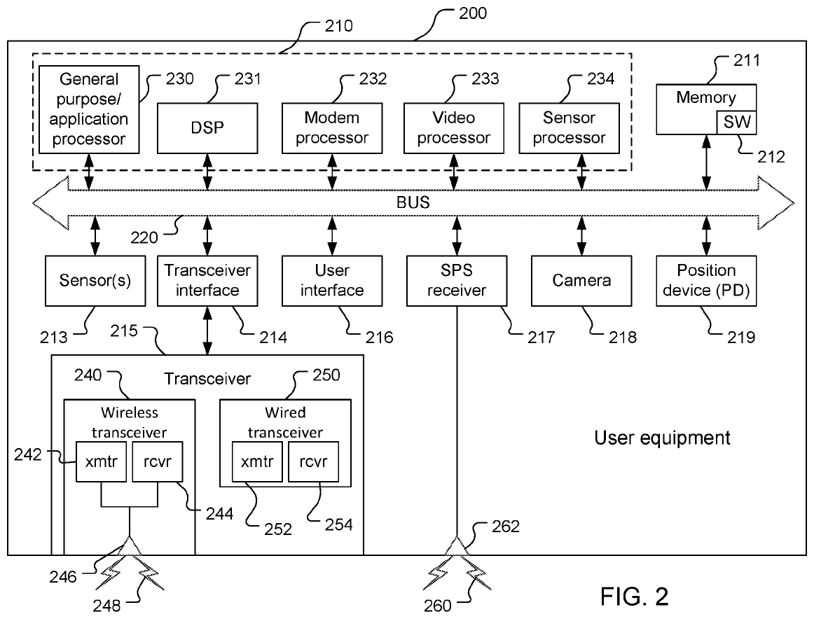

Referring also to FIG. 2, a UE 200 may be an example of one of the UEs 105, 106 and may comprise a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The processor 210 may include one or more intelligent hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 may be a non-transitory storage medium that may include random access memory (RAM), flash memory, disc memory, and/or read-only memory (ROM), etc. The memory 211 may store the software 212 which may be processor-readable, processor-executable software code containing instructions that may be configured to, when executed, cause the processor 210 to perform various functions described herein. Alternatively, the software 212 may not be directly executable by the processor 210 but may be configured to cause the processor 210, e.g., when compiled and executed, to perform the functions. The description herein may refer to the processor 210 performing a function, but this includes other implementations such as where the processor 210 executes software and/or firmware. The description herein may refer to the processor 210 performing a function as shorthand for one or more of the processors 230-234 performing the function. The description herein may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE may include one or more of the processors 230-234 of the processor 210, the memory 211, and the wireless transceiver 240. Other example configurations may include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The UE 200 may include the sensor(s) 213 that may include, for example, one or more of various types of sensors such as one or more inertial sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the UE 200 in three dimensions) and/or one or more gyroscopes (e.g., three-dimensional gyroscope(s)). The sensor(s) 213 may include one or more magnetometers (e.g., three-dimensional magnetometer(s)) to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose/application processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and may report the relative displacement/distance (e.g., via dead reckoning, or sensor-based location determination, or sensor-assisted location determination enabled by the sensor(s) 213). In another example, for relative positioning information, the sensors/IMU may be used to determine the angle and/or orientation of the other device with respect to the UE 200, etc.

The IMU may be configured to provide measurements about a direction of motion and/or a speed of motion of the UE 200, which may be used in relative location determination. For example, one or more accelerometers and/or one or more gyroscopes of the IMU may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) and gyroscope(s) taken after this moment in time may be used in dead reckoning to determine present location of the UE 200 based on movement (direction and distance) of the UE 200 relative to the reference location.

The magnetometer(s) may determine magnetic field strengths in different directions which may be used to determine orientation of the UE 200. For example, the orientation may be used to provide a digital compass for the UE 200. The magnetometer(s) may include a two-dimensional magnetometer configured to detect and provide indications of magnetic field strength in two orthogonal dimensions. The magnetometer(s) may include a three-dimensional magnetometer configured to detect and provide indications of magnetic field strength in three orthogonal dimensions. The magnetometer(s) may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. New Radio may use mm-wave frequencies and/or sub-6 GHz frequencies. The wired transceiver 250 may include a wired transmitter 252 and a wired receiver 254 configured for wired communication, e.g., a network interface that may be utilized to communicate with the NG-RAN 135 to send communications to, and receive communications from, the NG-RAN 135. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose/application processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose/application processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the UE 200 using terrestrial-based signals (e.g., at least some of the wireless signals 248) for trilateration, for assistance with obtaining and using the SPS signals 260, or both. The PD 219 may be configured to determine location of the UE 200 based on a cell of a serving base station (e.g., a cell center) and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the UE 200. The PD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the general-purpose/application processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the UE 200, and may be provided by hardware, software, firmware, or various combinations thereof.

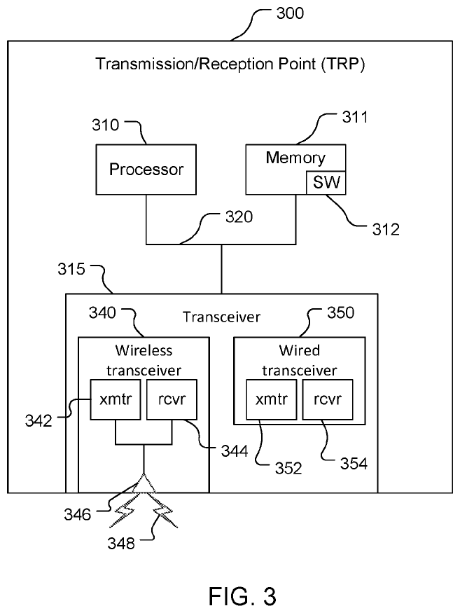

Referring also to FIG. 3, an example of a TRP 300 of the gNBs 110a, 110b and/or the ng-eNB 114 comprises a computing platform including a processor 310, memory 311 including software (SW) 312, and a transceiver 315. The processor 310, the memory 311, and the transceiver 315 may be communicatively coupled to each other by a bus 320 (which may be configured, e.g., for optical and/or electrical communication). One or more of the shown apparatus (e.g., a wireless transceiver) may be omitted from the TRP 300. The processor 310 may include one or more intelligent hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 may be a non-transitory storage medium that may include random access memory (RAM)), flash memory, disc memory, and/or read-only memory (ROM), etc. The memory 311 may store the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions.

The description herein may refer to the processor 310 performing a function, but this includes other implementations such as where the processor 310 executes software and/or firmware. The description herein may refer to the processor 310 performing a function as shorthand for one or more of the processors contained in the processor 310 performing the function. The description herein may refer to the TRP 300 performing a function as shorthand for one or more appropriate components (e.g., the processor 310 and the memory 311) of the TRP 300 (and thus of one of the gNBs 110a, 110b and/or the ng-eNB 114) performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to wired (e.g., electrical and/or optical) signals and from wired (e.g., electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 350 may include a wired transmitter 352 and a wired receiver 354 configured for wired communication, e.g., a network interface that may be utilized to communicate with the NG-RAN 135 to send communications to, and receive communications from, the LMF 120, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 may be configured to perform or performs several functions, but one or more of these functions may be performed by the LMF 120 and/or the UE 200 (i.e., the LMF 120 and/or the UE 200 may be configured to perform one or more of these functions).

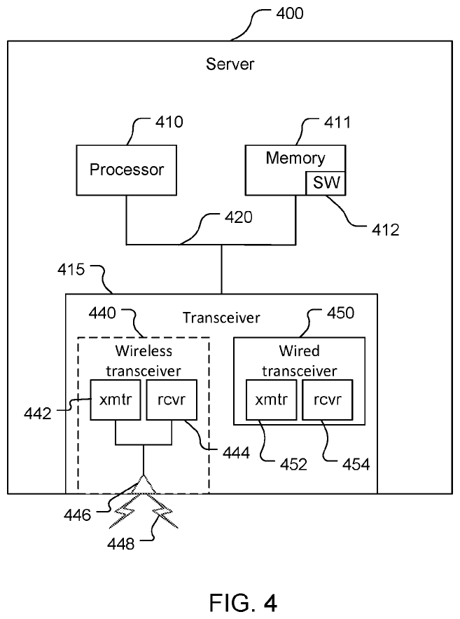

Referring also to FIG. 4, a server 400, of which the LMF 120 may be an example, may comprise a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless transceiver) may be omitted from the server 400. The processor 410 may include one or more intelligent hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 may be a non-transitory storage medium that may include random access memory (RAM)), flash memory, disc memory, and/or read-only memory (ROM), etc. The memory 411 may store the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description herein may refer to the processor 410 performing a function, but this includes other implementations such as where the processor 410 executes software and/or firmware. The description herein may refer to the processor 410 performing a function as shorthand for one or more of the processors contained in the processor 410 performing the function. The description herein may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 450 may include a wired transmitter 452 and a wired receiver 454 configured for wired communication, e.g., a network interface that may be utilized to communicate with the NG-RAN 135 to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The description herein may refer to the processor 410 performing a function, but this includes other implementations such as where the processor 410 executes software (stored in the memory 411) and/or firmware. The description herein may refer to the server 400 performing a function as shorthand for one or more appropriate components (e.g., the processor 410 and the memory 411) of the server 400 performing the function.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

### Positioning Techniques

For terrestrial positioning of a UE in cellular networks, techniques such as Advanced Forward Link Trilateration (AFLT) and Observed Time Difference Of Arrival (OTDOA) often operate in “UE-assisted” mode in which measurements of reference signals (e.g., PRS, CRS, etc.) transmitted by base stations are taken by the UE and then provided to a location server. The location server then calculates the position of the UE based on the measurements and known locations of the base stations. Because these techniques use the location server to calculate the position of the UE, rather than the UE itself, these positioning techniques are not frequently used in applications such as car or cell-phone navigation, which instead typically rely on satellite-based positioning.

A UE may use a Satellite Positioning System (SPS) (a Global Navigation Satellite System (GNSS)) for high-accuracy positioning using precise point positioning (PPP) or real time kinematic (RTK) technology. These technologies use assistance data such as measurements from ground-based stations. LTE Release 15 allows the data to be encrypted so that the UEs subscribed to the service exclusively can read the information. Such assistance data varies with time. Thus, a UE subscribed to the service may not easily “break encryption” for other UEs by passing on the data to other UEs that have not paid for the subscription. The passing on would need to be repeated every time the assistance data changes.

In UE-assisted positioning, the UE sends measurements (e.g., TDOA, Angle of Arrival (AoA), etc.) to the positioning server (e.g., LMF/eSMLC). The positioning server has the base station almanac (BSA) that contains multiple ‘entries’ or ‘records’, one record per cell, where each record contains geographical cell location but also may include other data. An identifier of the ‘record’ among the multiple ‘records’ in the BSA may be referenced. The BSA and the measurements from the UE may be used to compute the position of the UE.

In conventional UE-based positioning, a UE computes its own position, thus avoiding sending measurements to the network (e.g., location server), which in turn improves latency and scalability. The UE uses relevant BSA record information (e.g., locations of gNBs (more broadly base stations)) from the network. The BSA information may be encrypted. But since the BSA information varies much less often than, for example, the PPP or RTK assistance data described earlier, it may be easier to make the BSA information (compared to the PPP or RTK information) available to UEs that did not subscribe and pay for decryption keys. Transmissions of reference signals by the gNBs make BSA information potentially accessible to crowd-sourcing or war-driving, essentially enabling BSA information to be generated based on in-the-field and/or over-the-top observations.

Positioning techniques may be characterized and/or assessed based on one or more criteria such as position determination accuracy and/or latency. Latency is a time elapsed between an event that triggers determination of position-related data and the availability of that data at a positioning system interface, e.g., an interface of the LMF 120. At initialization of a positioning system, the latency for the availability of position-related data is called time to first fix (TTFF), and is larger than latencies after the TTFF. An inverse of a time elapsed between two consecutive position-related data availabilities is called an update rate, i.e., the rate at which position-related data are generated after the first fix. Latency may depend on processing capability, e.g., of the UE. For example, a UE may report a processing capability of the UE as a duration of DL PRS symbols in units of time (e.g., milliseconds) that the UE can process every T amount of time (e.g., T ms) assuming 272 PRB (Physical Resource Block) allocation. Other examples of capabilities that may affect latency are a number of TRPs from which the UE can process PRS, a number of PRS that the UE can process, and a bandwidth of the UE.

One or more of many different positioning techniques (also called positioning methods) may be used to determine position of an entity such as one of the UEs 105, 106. For example, known position-determination techniques include RTT, multi-RTT, OTDOA (also called TDOA and including UL-TDOA and DL-TDOA), Enhanced Cell Identification (E-CID), DL-AoD, UL-AoA, etc. RTT uses a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. In TDOA techniques, the difference in travel times between one entity and other entities may be used to determine relative ranges from the other entities and those, combined with known locations of the other entities may be used to determine the location of the one entity. Angles of arrival and/or departure may be used to help determine location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). E-CID uses the identity of a serving cell, the timing advance (i.e., the difference between receive and transmit times at the UE), estimated timing and power of detected neighbor cell signals, and possibly angle of arrival (e.g., of a signal at the UE from the base station or vice versa) to determine location of the UE. In TDOA, the difference in arrival times at a receiving device of signals from different sources along with known locations of the sources and known offset of transmission times from the sources are used to determine the location of the receiving device.

In a network-centric RTT estimation, the serving base station instructs the UE to scan for/receive RTT measurement signals (e.g., PRS) on serving cells of two or more neighboring base stations (and typically the serving base station, as at least three base stations are needed). The one of more base stations transmit RTT measurement signals on low reuse resources (e.g., resources used by the base station to transmit system information) allocated by the network (e.g., a location server such as the LMF 120). The UE records the arrival time (also referred to as a receive time, a reception time, a time of reception, or a time of arrival (ToA)) of each RTT measurement signal relative to the UE's current downlink timing (e.g., as derived by the UE from a DL signal received from its serving base station), and transmits a common or individual RTT response message (e.g., SRS (sounding reference signal) for positioning, i.e., UL-PRS) to the one or more base stations (e.g., when instructed by its serving base station) and may include the time difference T_{Rx→Tx} (i.e., UE T_{Rx-Tx} or UE_{Rx-Tx}) between the ToA of the RTT measurement signal and the transmission time of the RTT response message in a payload of each RTT response message. The RTT response message would include a reference signal from which the base station can deduce the ToA of the RTT response. By comparing the difference T_{Tx→Rx} between the transmission time of the RTT measurement signal from the base station and the ToA of the RTT response at the base station to the UE-reported time difference T_{Rx→Tx}, the base station can deduce the propagation time between the base station and the UE, from which the base station can determine the distance between the UE and the base station by assuming the speed of light during this propagation time.

A UE-centric RTT estimation is similar to the network-based method, except that the UE transmits uplink RTT measurement signal(s) (e.g., when instructed by a serving base station), which are received by multiple base stations in the neighborhood of the UE. Each involved base station responds with a downlink RTT response message, which may include the time difference between the ToA of the RTT measurement signal at the base station and the transmission time of the RTT response message from the base station in the RTT response message payload.

For both network-centric and UE-centric procedures, the side (network or UE) that performs the RTT calculation typically (though not always) transmits the first message(s) or signal(s) (e.g., RTT measurement signal(s)), while the other side responds with one or more RTT response message(s) or signal(s) that may include the difference between the ToA of the first message(s) or signal(s) and the transmission time of the RTT response message(s) or signal(s).

A multi-RTT technique may be used to determine position. For example, a first entity (e.g., a UE) may send out one or more signals (e.g., unicast, multicast, or broadcast from the base station) and multiple second entities (e.g., other TSPs such as base station(s) and/or UE(s)) may receive a signal from the first entity and respond to this received signal. The first entity receives the responses from the multiple second entities. The first entity (or another entity such as an LMF) may use the responses from the second entities to determine ranges to the second entities and may use the multiple ranges and known locations of the second entities to determine the location of the first entity by trilateration.

In some instances, additional information may be obtained in the form of an angle of arrival (AoA) or angle of departure (AoD) that defines a straight-line direction (e.g., which may be in a horizontal plane or in three dimensions) or possibly a range of directions (e.g., for the UE from the locations of base stations). The intersection of two directions can provide another estimate of the location for the UE.

For positioning techniques using PRS (Positioning Reference Signal) signals (e.g., TDOA and RTT), PRS signals sent by multiple TRPs are measured and the arrival times of the signals, known transmission times, and known locations of the TRPs used to determine ranges from a UE to the TRPs. For example, an RSTD (Reference Signal Time Difference) may be determined for PRS signals received from multiple TRPs and used in a TDOA technique to determine position (location) of the UE. A positioning reference signal may be referred to as a PRS or a PRS signal. The PRS signals are typically sent using the same power and PRS signals with the same signal characteristics (e.g., same frequency shift) may interfere with each other such that a PRS signal from a more distant TRP may be overwhelmed by a PRS signal from a closer TRP such that the signal from the more distant TRP may not be detected. PRS muting may be used to help reduce interference by muting some PRS signals (reducing the power of the PRS signal, e.g., to zero and thus not transmitting the PRS signal). In this way, a weaker (at the UE) PRS signal may be more easily detected by the UE without a stronger PRS signal interfering with the weaker PRS signal. The term RS, and variations thereof (e.g., PRS, SRS, CSI-RS (Channel State Information-Reference Signal)), may refer to one reference signal or more than one reference signal.

Positioning reference signals (PRS) include downlink PRS (DL PRS, often referred to simply as PRS) and uplink PRS (UL PRS) (which may be called SRS (Sounding Reference Signal) for positioning). A PRS may comprise a PN code (pseudorandom number code) or be generated using a PN code (e.g., by modulating a carrier signal with the PN code) such that a source of the PRS may serve as a pseudo-satellite (a pseudolite). The PN code may be unique to the PRS source (at least within a specified area such that identical PRS from different PRS sources do not overlap). PRS may comprise PRS resources and/or PRS resource sets of a frequency layer. A DL PRS positioning frequency layer (or simply a frequency layer) is a collection of DL PRS resource sets, from one or more TRPs, with PRS resource(s) that have common parameters configured by higher-layer parameters DL-PRS-PositioningFrequencyLayer, DL-PRS-ResourceSet, and DL-PRS-Resource. Each frequency layer has a DL PRS subcarrier spacing (SCS) for the DL PRS resource sets and the DL PRS resources in the frequency layer. Each frequency layer has a DL PRS cyclic prefix (CP) for the DL PRS resource sets and the DL PRS resources in the frequency layer. In 5G, a resource block occupies 12 consecutive subcarriers and a specified number of symbols. Common resource blocks are the set of resource blocks that occupy a channel bandwidth. A bandwidth part (BWP) is a set of contiguous common resource blocks and may include all the common resource blocks within a channel bandwidth or a subset of the common resource blocks. Also, a DL PRS Point A parameter defines a frequency of a reference resource block (and the lowest subcarrier of the resource block), with DL PRS resources belonging to the same DL PRS resource set having the same Point A and all DL PRS resource sets belonging to the same frequency layer having the same Point A. A frequency layer also has the same DL PRS bandwidth, the same start PRB (and center frequency), and the same value of comb size (i.e., a frequency of PRS resource elements per symbol such that for comb-N, every Nth resource element is a PRS resource element). A PRS resource set is identified by a PRS resource set ID and may be associated with a particular TRP (identified by a cell ID) transmitted by an antenna panel of a base station. A PRS resource ID in a PRS resource set may be associated with an omnidirectional signal, and/or with a single beam (and/or beam ID) transmitted from a single base station (where a base station may transmit one or more beams). Each PRS resource of a PRS resource set may be transmitted on a different beam and as such, a PRS resource (or simply resource) can also be referred to as a beam. This does not have any implications on whether the base stations and the beams on which PRS are transmitted are known to the UE.

A TRP may be configured, e.g., by instructions received from a server and/or by software in the TRP, to send DL PRS per a schedule. According to the schedule, the TRP may send the DL PRS intermittently, e.g., periodically at a consistent interval from an initial transmission. The TRP may be configured to send one or more PRS resource sets. A resource set is a collection of PRS resources across one TRP, with the resources having the same periodicity, a common muting pattern configuration (if any), and the same repetition factor across slots. Each of the PRS resource sets comprises multiple PRS resources, with each PRS resource comprising multiple OFDM (Orthogonal Frequency Division Multiplexing) Resource Elements (REs) that may be in multiple Resource Blocks (RBs) within N (one or more) consecutive symbol(s) within a slot. PRS resources (or reference signal (RS) resources generally) may be referred to as OFDM PRS resources (or OFDM RS resources). An RB is a collection of REs spanning a quantity of one or more consecutive symbols in the time domain and a quantity (12 for a 5G RB) of consecutive sub-carriers in the frequency domain. Each PRS resource is configured with an RE offset, slot offset, a symbol offset within a slot, and a number of consecutive symbols that the PRS resource may occupy within a slot. The RE offset defines the starting RE offset of the first symbol within a DL PRS resource in frequency. The relative RE offsets of the remaining symbols within a DL PRS resource are defined based on the initial offset. The slot offset is the starting slot of the DL PRS resource with respect to a corresponding resource set slot offset. The symbol offset determines the starting symbol of the DL PRS resource within the starting slot. Transmitted REs may repeat across slots, with each transmission being called a repetition such that there may be multiple repetitions in a PRS resource. The DL PRS resources in a DL PRS resource set are associated with the same TRP and each DL PRS resource has a DL PRS resource ID. A DL PRS resource ID in a DL PRS resource set is associated with a single beam transmitted from a single TRP (although a TRP may transmit one or more beams).

A PRS resource may also be defined by quasi-co-location and start PRB parameters. A quasi-co-location (QCL) parameter may define any quasi-co-location information of the DL PRS resource with other reference signals. The DL PRS may be configured to be QCL type D with a DL PRS or SS/PBCH (Synchronization Signal/Physical Broadcast Channel) Block from a serving cell or a non-serving cell. The DL PRS may be configured to be QCL type C with an SS/PBCH Block from a serving cell or a non-serving cell. The start PRB parameter defines the starting PRB index of the DL PRS resource with respect to reference Point A. The starting PRB index has a granularity of one PRB and may have a minimum value of 0 and a maximum value of 2176 PRBs.

A PRS resource set is a collection of PRS resources with the same periodicity, same muting pattern configuration (if any), and the same repetition factor across slots. Every time all repetitions of all PRS resources of the PRS resource set are configured to be transmitted is referred as an “instance”. Therefore, an “instance” of a PRS resource set is a specified number of repetitions for each PRS resource and a specified number of PRS resources within the PRS resource set such that once the specified number of repetitions are transmitted for each of the specified number of PRS resources, the instance is complete. An instance may also be referred to as an “occasion.” A DL PRS configuration including a DL PRS transmission schedule may be provided to a UE to facilitate (or even enable) the UE to measure the DL PRS.

Multiple frequency layers of PRS may be aggregated to provide an effective bandwidth that is larger than any of the bandwidths of the layers individually. Multiple frequency layers of component carriers (which may be consecutive and/or separate) and meeting criteria such as being quasi co-located (QCLed), and having the same antenna port, may be stitched to provide a larger effective PRS bandwidth (for DL PRS and UL PRS) resulting in increased time of arrival measurement accuracy. Stitching comprises combining PRS measurements over individual bandwidth fragments into a unified piece such that the stitched PRS may be treated as having been taken from a single measurement. Being QCLed, the different frequency layers behave similarly, enabling stitching of the PRS to yield the larger effective bandwidth. The larger effective bandwidth, which may be referred to as the bandwidth of an aggregated PRS or the frequency bandwidth of an aggregated PRS, provides for better time-domain resolution (e.g., of TDOA). An aggregated PRS includes a collection of PRS resources and each PRS resource of an aggregated PRS may be called a PRS component, and each PRS component may be transmitted on different component carriers, bands, or frequency layers, or on different portions of the same band.

RTT positioning is an active positioning technique in that RTT uses positioning signals sent by TRPs to UEs and by UEs (that are participating in RTT positioning) to TRPs. The TRPs may send DL-PRS signals that are received by the UEs and the UEs may send SRS (Sounding Reference Signal) signals that are received by multiple TRPs. A sounding reference signal may be referred to as an SRS or an SRS signal. In 5G multi-RTT, coordinated positioning may be used with the UE sending a single UL-SRS for positioning that is received by multiple TRPs instead of sending a separate UL-SRS for positioning for each TRP. A TRP that participates in multi-RTT will typically search for UEs that are currently camped on that TRP (served UEs, with the TRP being a serving TRP) and also UEs that are camped on neighboring TRPs (neighbor UEs). Neighbor TRPs may be TRPs of a single BTS (Base Transceiver Station) (e.g., gNB), or may be a TRP of one BTS and a TRP of a separate BTS. For RTT positioning, including multi-RTT positioning, the DL-PRS signal and the UL-SRS for positioning signal in a PRS/SRS for positioning signal pair used to determine RTT (and thus used to determine range between the UE and the TRP) may occur close in time to each other such that errors due to UE motion and/or UE clock drift and/or TRP clock drift are within acceptable limits. For example, signals in a PRS/SRS for positioning signal pair may be transmitted from the TRP and the UE, respectively, within about 10 ms of each other. With SRS for positioning being sent by UEs, and with PRS and SRS for positioning being conveyed close in time to each other, it has been found that radio-frequency (RF) signal congestion may result (which may cause excessive noise, etc.) especially if many UEs attempt positioning concurrently and/or that computational congestion may result at the TRPs that are trying to measure many UEs concurrently.

RTT positioning may be UE-based or UE-assisted. In UE-based RTT, the UE 200 determines the RTT and corresponding range to each of the TRPs 300 and the position of the UE 200 based on the ranges to the TRPs 300 and known locations of the TRPs 300. In UE-assisted RTT, the UE 200 measures positioning signals and provides measurement information to the TRP 300, and the TRP 300 determines the RTT and range. The TRP 300 provides ranges to a location server, e.g., the server 400, and the server determines the location of the UE 200, e.g., based on ranges to different TRPs 300. The RTT and/or range may be determined by the TRP 300 that received the signal(s) from the UE 200, by this TRP 300 in combination with one or more other devices, e.g., one or more other TRPs 300 and/or the server 400, or by one or more devices other than the TRP 300 that received the signal(s) from the UE 200.

Various positioning techniques are supported in 5G NR. The NR native positioning methods supported in 5G NR include DL-only positioning methods, UL-only positioning methods, and DL+UL positioning methods. Downlink-based positioning methods include DL-TDOA and DL-AoD. Uplink-based positioning methods include UL-TDOA and UL-AoA. Combined DL+UL-based positioning methods include RTT with one base station and RTT with multiple base stations (multi-RTT).

A position estimate (e.g., for a UE) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence).

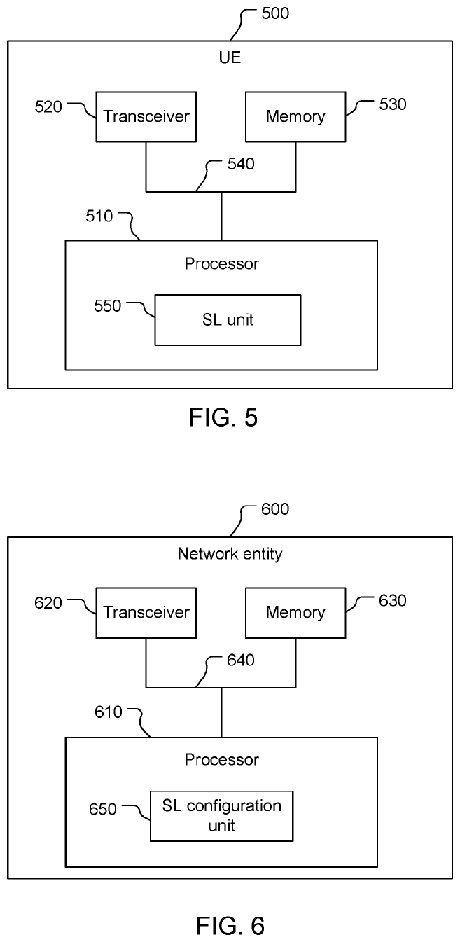

Referring also to FIG. 5, a UE 500 includes a processor 510, a transceiver 520, and a memory 530 communicatively coupled to each other by a bus 540. The UE 500 may include the components shown in FIG. 5. The UE 500 may include one or more other components such as any of those shown in FIG. 2 such that the UE 200 may be an example of the UE 500. For example, the processor 510 may include one or more of the components of the processor 210. The transceiver 520 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the transceiver 520 may include the wired transmitter 252 and/or the wired receiver 254. The memory 530 may be configured similarly to the memory 211, e.g., including software with processor-readable instructions configured to cause the processor 510 to perform functions.

The description herein may refer to the processor 510 performing a function, but this includes other implementations such as where the processor 510 executes software (stored in the memory 530) and/or firmware. The description herein may refer to the UE 500 performing a function as shorthand for one or more appropriate components (e.g., the processor 510 and the memory 530) of the UE 500 performing the function. The processor 510 (possibly in conjunction with the memory 530 and, as appropriate, the transceiver 520) may include an SL unit 550 (sidelink unit). The SL unit 550 is discussed further below, and the description may refer to the processor 510 generally, or the UE 500 generally, as performing any of the functions of the SL unit 550. The UE 500 is configured to perform the functions of the SL unit 550 discussed herein.

Referring also to FIG. 6, a network entity 600 includes a processor 610, a transceiver 620, and a memory 630 communicatively coupled to each other by a bus 640. The network entity 600 may include the components shown in FIG. 6. The network entity 600 may include one or more other components such as any of those shown in FIG. 3 and/or FIG. 4 such that the TRP 300 and/or the server 400 may be an example of the network entity 600. For example, the processor 610 may include one or more of the components of the processor 310 and/or the processor 410. The transceiver 620 may include one or more of the components of the transceiver 315 and/or the transceiver 415. The memory 630 may be configured similarly to the memory 311 and/or the memory 411, e.g., including software with processor-readable instructions configured to cause the processor 610 to perform functions.

The description herein may refer to the processor 610 performing a function, but this includes other implementations such as where the processor 610 executes software (stored in the memory 630) and/or firmware. The description herein may refer to the network entity 600 performing a function as shorthand for one or more appropriate components (e.g., the processor 610 and the memory 630) of the network entity 600 performing the function. The processor 610 (possibly in conjunction with the memory 630 and, as appropriate, the transceiver 620) may include an SL configuration unit 650. The SL configuration unit 650 is discussed further below, and the description may refer to the processor 610 generally, or the network entity 600 generally, as performing any of the functions of the SL configuration unit 650. The network entity 600 is configured to perform the functions of the SL configuration unit 650 discussed herein.

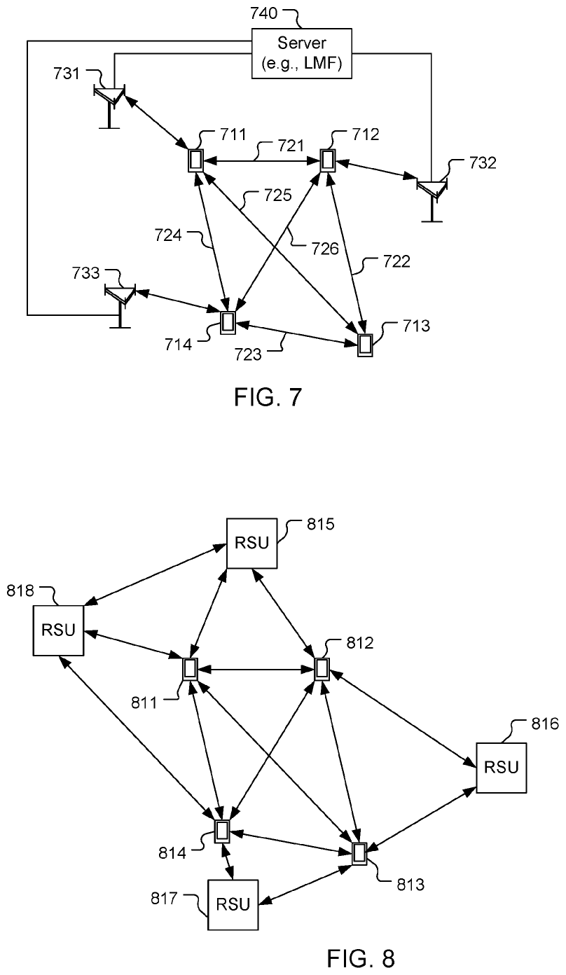

Referring also to FIG. 7, multiple UEs 711, 712, 713, 714 (e.g., examples of the UE 500) may transmit and/or receive reference signals and/or data signals with each other through sidelink (SL) connections 721, 722, 723, 724, 725, 726 assisted by one or more TRPs 731, 732, 733 (e.g., examples of the TRP 300) connected to a server 740 (e.g., an example of the server 400). Network-assisted (or network-scheduled) sidelink operation as shown in FIG. 7 is referred to as mode 1. In mode 1, for each of the UEs 711-714, the network (e.g., a TRP) schedules resources, e.g., PRS resources, or at least some resource configuration parameters are provided by a respective serving TRP (which may be the same TRP for multiple UEs). The resources for SL transmission may be allocated dynamically (e.g., via DCI (Downlink Control Information) format 3-x) or statically (e.g., during manufacture of UEs) for Type-1 or Type-2 transmissions. For positioning, the server 740 coordinates PRS deployment across the TRPs 731-733 and the UEs 711-714, configuring resource pools and configuring SL-PRS resource sets for each UE. Each resource pool defines available OFDM (orthogonal frequency division multiplexing) resources (e.g., specifying slots, resource blocks, and resource elements) for either sidelink transmission or sidelink reception. The resource pool provides a time/frequency opportunity for UEs to transmit or receive signals in sidelink. For UE-based positioning, the UE 711 may use sidelink and Uu measurements (e.g., measurements of signals transferred between the UE 711 and the TRP 731) to compute a position estimate for the UE 711. The server 740 may provide the UE 711 with one or more measurements from one or more of the UEs 712-714. For UE-assisted positioning. the server 740 may compute a position estimate for the UE 711 using sidelink measurements and Uu measurements reported to the server 740).

Referring also to FIG. 8, multiple UEs 811, 812, 813, 814, 815, 816, 817, 818 (e.g., examples of the UE 500) may transmit and/or receive positioning signals and/or data signals with each other through sidelink (SL) connections without assistance from any TRPs in an operational mode commonly referred to as mode 2 (or UE-scheduled sidelink operation). In mode 2, based on a configured resource pool of OFDM resources (e.g., as indicated by one or more layers of the UEs 811-818 above the physical layer), and based on channel sensing using a control signal (e.g., SCI-1 (sidelink control information-1), the UEs 811-818 may autonomously choose some resources from the pool to use for SL-PRS transmission. The UEs 811-818 may choose resources based on the channel sensing, e.g., priority of different transmissions and an RSRP. The UEs 811-818 may broadcast SL-PRS assistance data using one or more SL data channels. Each of the UEs 811-818 may perform measurements and distribute information (e.g., RTT delay within the UE) to nearby UEs. Each of the UEs 811-814 may compute a position estimate based on SL-PRS measurements made by that UE and based on indications, received by the UE, of measurements made by other UEs. The UEs 815-818 in this example are roadside units (RSUs) that may be stationary with well-known locations to facilitate determination of position estimates for the UEs 811-814. For a UE that is in coverage of a TRP, the TRP can adopt mode 1 or mode 2 for the UE, while a UE that is out of coverage (out of range of any TRPs), mode 2 is used.

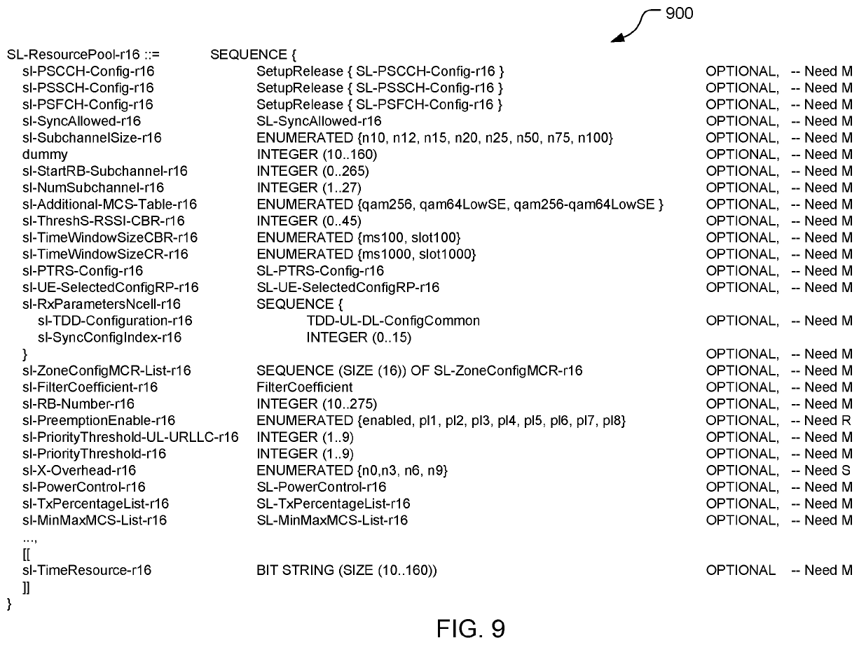

Resource pools presently exist for data communications, but not for positioning. For example, referring to FIG. 9, an SL-RP configuration 900 (sidelink resource pool configuration) for release 16 of the 3GPP 5G NR standard includes fields of information shown. For example, the SL-RP configuration 900 includes a sidelink PSCCH configuration, an SL PSSCH configuration, an SL PSFCH configuration, subchannel size, number of subchannels, start RB, etc.

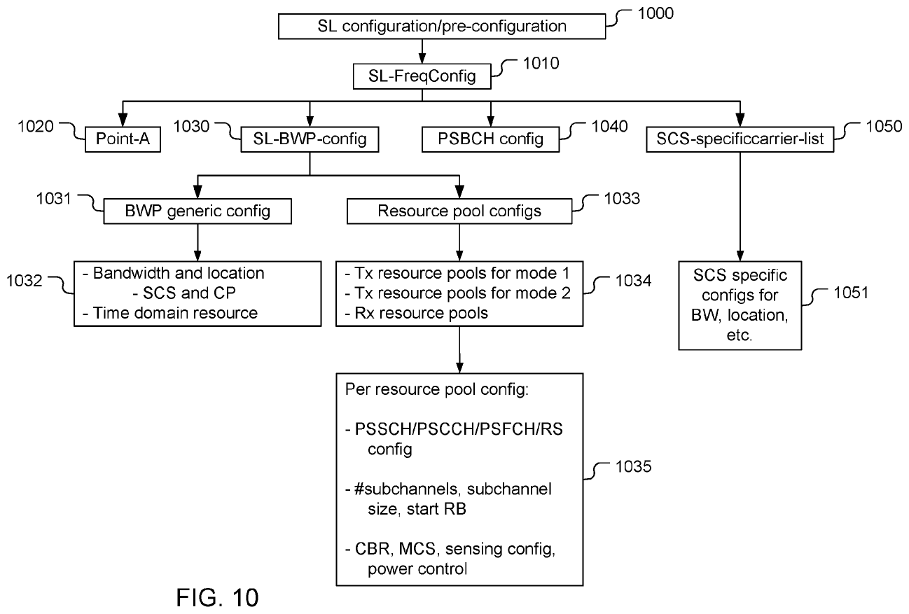

Referring also to FIG. 10, various SL configuration items of an SL configuration/pre-configuration 1000 are shown. The network entity 600, e.g., the SL configuration unit 650, may be configured to obtain (e.g., establish) and disseminate the SL configuration/pre-configuration 1000 and/or the UE 500 may be configured to obtain (e.g., retrieve from memory, receive from the network entity 600), disseminate, and use the SL configuration/pre-configuration 1000 to transmit and/or receive SL signals (e.g., data, communication, RS). For example, the SL unit 550 may have the SL configuration/pre-configuration 1000 stored during manufacture or may receive the SL configuration/pre-configuration 1300 during use, e.g., from the network entity 600. A received SL configuration may override an SL pre-configuration (stored in the memory 530). The SL configuration unit 650 may obtain the SL configuration/pre-configuration 1000, e.g., by receiving or generating the SL configuration/pre-configuration 1000.

The SL configuration/pre-configuration 1000, as shown, includes various configurations and configuration parameters of respective configurations. The SL configuration/pre-configuration 1000 is for an SL frequency configuration 1010, which is equivalent to a carrier for a Uu interface. The SL frequency configuration 1010 includes a point-A 1020, an SL-BWP configuration 1030, a PSBCH configuration 1040, and an SCS-specific carrier list 1050. The SL-BWP configuration 1030 includes a BWP generic configuration 1031 and resource pool configurations 1033. The BWP generic configuration 1031 includes a BWP generic configuration parameter collection 1032 of configuration parameters including bandwidth, location, subcarrier spacing, cyclic prefix, and time domain resource (e.g., periodicity). The location is a frequency domain location (e.g., a start frequency and an end frequency, or a start frequency and a frequency length, or a start frequency relative to the Point A). These configuration parameters are generic across all resource pools and OFDM resources within the SL-BWP configuration 1030. The resource pool configurations 1033 include a resource pool collection 1034 including transmit (Tx) resource pools for mode 1, Tx resource pools for mode 2, and receive (Rx) resource pools. While the same Rx resource pools may be used for mode 1 or mode 2, separate Rx resource pools could be provided for mode 1 and mode 2. For each of the resource pools there is a resource pool configuration 1035 including a PSSCH configuration, a PSCCH configuration, a PSFCH (physical sidelink feedback channel) configuration, an RS configuration, a number of subchannels parameter, a subchannel size parameter, a start RB parameter, a channel busy ratio (CBR) parameter, a modulation and coding scheme (MCS) parameter, a channel sensing configuration, and a power control parameter. Thus, each resource pool may have different PSSCH, PSCCH, PSFCH, and/or RS configurations (for transmitting data (including communication), control information, feedback information, and RS, respectively), and/or different channel sensing configurations, and/or may have different values of one or more of the parameters listed. The SCS-specific carrier list 1050 includes SCS specific configurations 1051 for bandwidth, location, etc. for each carrier of a corresponding SCS.

In the SL configuration/pre-configuration 1000, RS resources are within a resource pool for control, data, and communication. Some resources are designated for one or more reference signals and other resources are designated for data, with all the resources sharing the bandwidth, location, SCS, CP, and time domain resource specified in the BWP generic configuration parameter collection 1032.

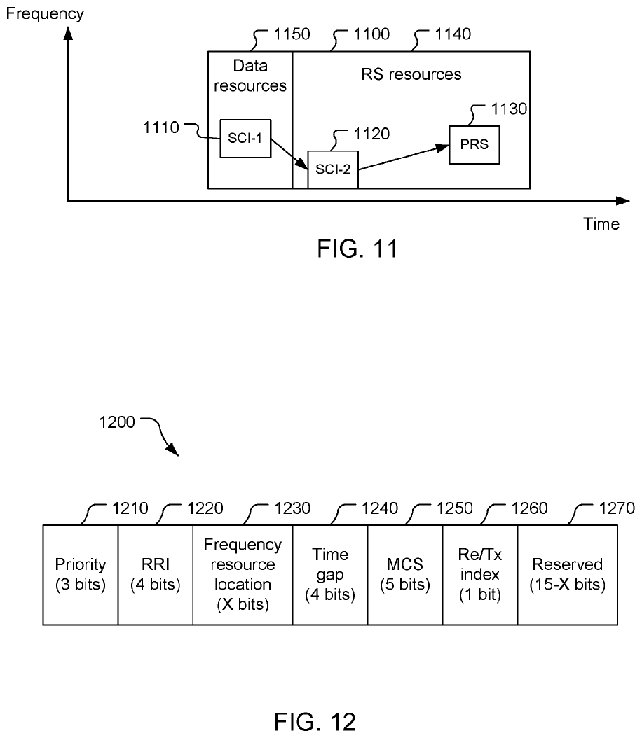

For each resource pool, control information for processing (e.g., locating and measuring) RS is provided on the PSCCH of the resource pool configuration 1035. Referring also to FIG. 11, two-stage control information is provided in a resource pool 1100. The two-stage control information comprises a first stage sidelink control information signal, an SCI-1 signal 1110, and a second stage sidelink control information signal, an SCI-2 signal 1120, and may be transmitted by the UE 500 (e.g., the SL unit 550) to direct a receiving UE to a resource location for processing an RS. Each of the SCI-1 signal 1110 and the SCI-2 signal 1120 contain a respective payload and a respective RS that is used to demodulate the respective payload. The payload of the SCI-1 signal 1110 includes a UE ID indicating for which UE the SCI-1 1110 signal is intended, and includes a pointer to the SCI-2 signal 1120, and the payload of the SCI-2 signal 1120 includes a pointer to the SL-RS, here the PRS 1130. The UE for which the SCI-1 signal 1110 is intended can decode the information in the SCI-1 signal 1110 to determine the location of the SCI-2 signal 1120. Another UE, for which the SCI-1 signal 1110 is not intended, can ignore the SCI-1 signal 1110 and the SCI-2 signal 1120 once the other UE determines that the SCI-1 signal 1110 is intended for a different UE. The SCI-2 signal 1120 includes information about a resource location of (e.g., the resources containing) an SL-RS, e.g., an SL-PRS 1130, of the resources of the resource pool designated for carrying RS. From the SCI-2 signal 1120, a UE can obtain resource location for the SL-RS. A legacy UE, that does not expect the SCI-2 signal 1120 to point to SL-RS will not be able to interpret the payload of the SCI-2 signal 1120 even if the legacy UE is provided with a scrambling code for the SCI-2 signal. The unscrambled bitstring will not make sense to the legacy UE.

Referring also to FIG. 12, the SCI-1 signal 1110 may be in a legacy SCI-1 format 1200, i.e., the same format as an SCI-1 signal for a resource pool for data only (not including resources for RS). The legacy SCI-1 format 1200 includes a priority field 1210, an RRI field 1220 (Resource Reservation Interval), a frequency resource location field 1230, a time gap field 1240, an MCS field 1250, a receive/transmit index field 1260, and a reserved field 1270 for future assignment. The frequency resource location field 1230 contains a pointer to the resource location of the SCI-2 signal 1120. The SCI-1 signal 1110 in the legacy format contains no SL-RS configuration information. Thus, a UE that does not expect the resource pool to be used for RS can read the SCI-1 signal 1110 and determine that indicated resources are in use, but will not decode the SCI-2 signal 1120, e.g., because a legacy UE, that is not configured to use a resource pool with reference signal resources, will not have, and/or not know to use, the payload of the SCI-2 signal 1120. As shown, the SCI-2 signal 1120 is in RS resources 1140 of the resource pool 1100 and the SCI-1 signal is in data resources 1150 of the resource pool 1100. Thus, an SL-RS (e.g., for positioning) may be defined within a resource pool that is shared by data and one or more reference signals (i.e., not a separate resource pool dedicated to RS), and reservation of resources may occur with a legacy SCI-1 signal (with no RS configuration) for the SCI-2 signal which is modified from the legacy SCI-2 signal to indicate one or more defined SL-RS configurations.

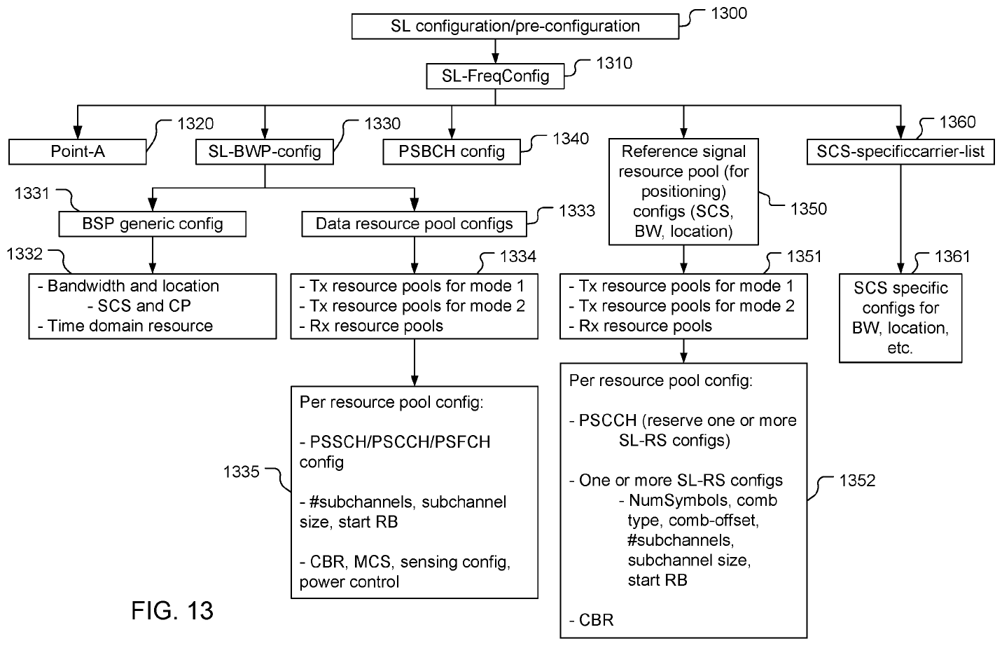

Referring also to FIG. 13, various SL configuration items of an SL configuration/pre-configuration 1300 are shown. The network entity 600, e.g., the SL configuration unit 650, may be configured to obtain and disseminate the SL configuration/pre-configuration 1300 and/or the UE 500 may be configured to obtain (e.g., retrieve from memory, receive from the network entity 600), disseminate, and use the SL configuration/pre-configuration 1300 to transmit and/or receive SL signals (e.g., data, communication, RS). For example, the SL unit 550 may have the SL configuration/pre-configuration 1300 stored during manufacture or may receive the SL configuration/pre-configuration 1300 during use, e.g., from the network entity 600. A received SL configuration may override an SL pre-configuration (stored in the memory 530). The SL configuration unit 650 may obtain the SL configuration/pre-configuration 1300, e.g., by receiving or generating the SL configuration/pre-configuration 1300. The SL configuration/pre-configuration 1300 differs from the SL configuration/pre-configuration in that the SL configuration/pre-configuration includes separate resource pools dedicated to reference signals, e.g., for positioning, with the resource pools for data being dedicated to data and not including resources for reference signals.

The SL configuration/pre-configuration 1300, as shown, includes various configurations and configuration parameters of respective configurations. The SL configuration/pre-configuration 1300 is for an SL frequency configuration 1310, which is equivalent to a carrier for a Uu interface. The SL frequency configuration 1310 includes a point-A 1320, an SL-BWP configuration 1330, a PSBCH configuration 1340, reference signal resource pool configurations 1350, and an SCS-specific carrier list 1360. The SL-BWP configuration 1330 includes a BWP generic configuration 1331 and data resource pool configurations 1333. The BWP generic configuration 1331 includes a BWP generic configuration parameter collection 1332 of configuration parameters including bandwidth, location, subcarrier spacing, cyclic prefix, and time domain resource (e.g., periodicity). These configuration parameters are generic across all resource pools and OFDM resources within the SL-BWP configuration 1330. The resource pool configurations 1333 include a resource pool collection 1334 including transmit (Tx) resource pools for mode 1, Tx resource pools for mode 2, and receive (Rx) resource pools. While the same Rx resource pools may be used for mode 1 or mode 2, separate Rx resource pools could be provided for mode 1 and mode 2. For each of the resource pools there is a resource pool configuration 1335 including a PSSCH configuration, a PSCCH configuration, a PSFCH (physical sidelink feedback channel) configuration, a number of subchannels parameter, a subchannel size parameter, a start RB parameter, a channel busy ratio (CBR) parameter, a modulation and coding scheme (MCS) parameter, a channel sensing configuration, and a power control parameter. Thus, each resource pool may have different PSSCH, PSCCH, and/or PSFCH configurations (for transmitting data (including communication), control information, and feedback information, respectively), and/or different channel sensing configurations, and/or may have different values of one or more of the parameters listed. The SCS-specific carrier list 1360 includes SCS specific configurations 1361 for bandwidth, location, etc. for each carrier of a corresponding SCS.

The reference signal resource pool configurations 1350 provide configurations for resource pools that are dedicated to reference signal transfer. The resource pools may convey RS and control information for using the resource pools to transfer the RS. The reference signal resource pools are separate from the data resource pools, with separate configurations that may have different values of similar configuration parameters. For example, the reference signal resource pool configurations 1350 have separate (from the data resource pools) configuration parameters of bandwidth, SCS, and location such that the respective value of one or more of these parameters may be different than the corresponding configuration parameter value of the data resource pools (indicated in the BWP generic configuration parameter collection 1332). For example, the bandwidth in the reference signal resource pool configurations 1350 may be larger than the bandwidth of the BWP generic configuration parameter collection 1332. The configuration parameters in the reference signal resource pool configurations 1350, however, are the same across all the reference signal resource pools. Thus, the resource pools for reference signals, e.g., resource pools for positioning, are defined separately from (outside of) other bandwidth parts within the SL frequency configuration 1310. The reference signal resource pool configurations 1350 have separately defined SCS, location in frequency, and potential point-A. A time gap may be scheduled for the UE 500 (e.g., by the network entity 600 or by the UE 500) to allow the UE 500 to perform radio frequency (RF) retuning for transitions between SL-BWP/DL-BWP/UL-BWP and a reference signal resource pool. The time gap and RF retuning may depend on capabilities of the UE 500 and whether the SCS, BW, location, and center frequency are the same or different. For example, if the SCS, BW, and center frequency for a reference signal resource pool and for the SL-BWP configuration 1330, then a time gap may not be scheduled.

The reference signal resource pool configurations 1350 include a resource pool collection 1351 including transmit (Tx) resource pools for mode 1, Tx resource pools for mode 2, and receive (Rx) resource pools. While the same Rx resource pools may be used for mode 1 or mode 2, separate Rx resource pools could be provided for mode 1 and mode 2. For each of the reference signal resource pools there is a resource pool configuration 1352 including a PSCCH configuration, one or more SL-RS configurations (e.g., SL-PRS configuration(s)), a number of symbols parameter, a comb type parameter, a comb-offset parameter, a number of subchannels parameter, a subchannel size parameter, a start RB parameter, a channel busy ratio (CBR) parameter, a channel sensing configuration, and a power control parameter. Thus, each reference signal resource pool may have different combinations of values of these configurations and parameters. The reference signal resource pools have separate parameters (with possibly different values) for channel sensing, CBR configuration, and power control.

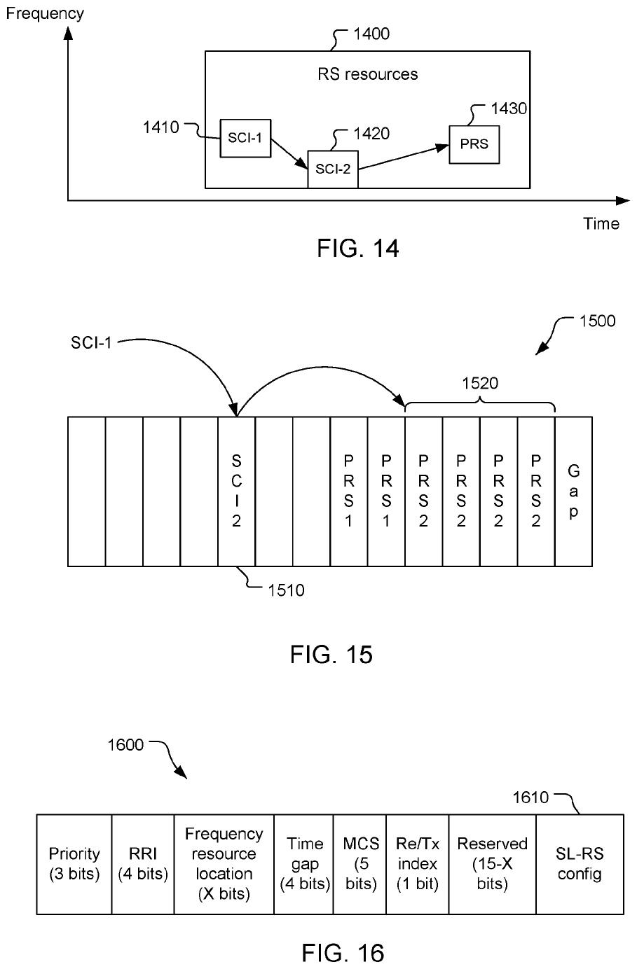

For each reference signal resource pool, control information for processing (e.g., locating and measuring) RS is provided on the PSCCH of the resource pool configuration 1352. For example, referring also to FIG. 14, two-stage control information may be provided in an RS resource pool 1400 to point to the resource location of an RS, here a PRS 1430. The two-stage control information comprises a first stage sidelink control information signal, an SCI-1 1410, and a second stage sidelink control information signal, an SCI-2 signal 1420, and may be transmitted by the UE 500 (e.g., the SL unit 550) to direct a receiving UE to a resource location for processing an RS. For example, referring also to FIG. 15, the SCI-1 signal 1410 may point to the SCI-2 signal 1420 in a symbol 1510 of a slot 1500 in a reference signal resource pool, and the SCI-2 signal 1420 may point to symbols 1520 containing a reference signal, here an SL-PRS labeled PRS2. The SCI-1 signal 1410 may, for example, be configured similarly to the SCI-1 signal 1110 discussed above (e.g., with the legacy SCI-1 format 1200). As another example, the SCI-1 signal 1410 may have a format that is different from the legacy SCI-1 format 1200. For example, referring also to FIG. 16, the SCI-1 signal 1410 may have an SCI-1 format 1600 that is similar to the SCI-1 format 1200, but including SL-RS configuration information 1610 to reserve one or more SL-RS configurations. A legacy UE, that is not configured to use a dedicated reference signal resource pool, may not properly interpret the SCI-2 signal 1420 while the UE 500 can properly interpret the SCI-2 signal 1420 to determine the resource location of the SL-RS, e.g., the PRS 1430.

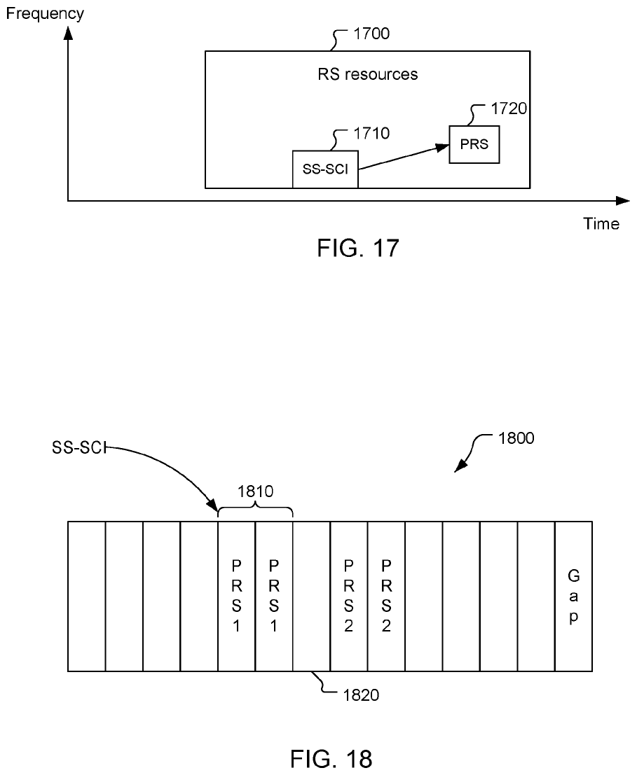

Referring also to FIGS. 17 and 18, as another example of control information for processing RS in a dedicated RS resource pool, single-stage sidelink control information signal, an SS-SC1 signal 1710, may be provided in an RS resource pool 1700 to point to the resource location of an RS, here a PRS 1720. The SS-SC1 signal 1710 may have a format that is different from the SCI-1 format 1200 such that a legacy UE, configured to decode the SCI-1 format 1200, may not properly decode the SS-SC1 signal 1710, i.e., not be able to interpret the SS-SCI signal 1710 properly, while the UE 500 can properly interpret the SS-SCI signal 1710. The UE 500 may decode the SS-SC1 signal 1710 to determine the resource location of SL-RS, e.g., the PRS 1720, indicated by the SS-SC1 signal 1710. The SS-SCI signal 1710 schedules RS in the dedicated RS resource pool, e.g., for positioning. The SS-SC1 signal 1710 may pick one or more RS configurations, e.g., one or more SL-PRS configurations. In the example of FIG. 18, the SS-SC1 signal 1710 points to the resource location, in a slot 1800, of an SL-PRS 1810 labeled PRS1. A guard symbol 1820 may be scheduled between RS from different UEs to allow for AGC (automatic gain control) training, e.g., to adjust for different signal strengths due to different signal transmission powers and/or different distances from the receiving UE to the transmitting UEs.

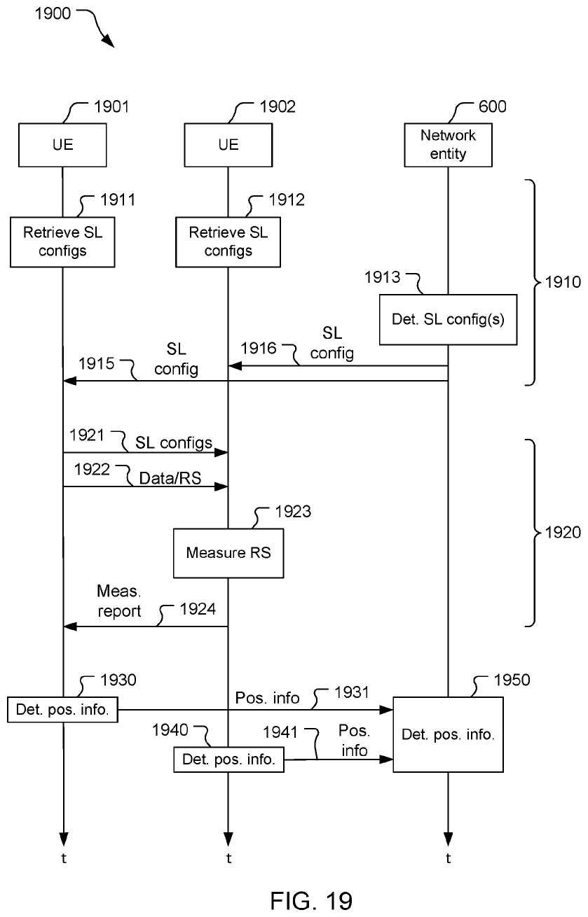

Referring to FIG. 19, with further reference to FIGS. 1-18, a timing diagram shows a signaling and process flow 1900 that includes the stages shown. The flow 1900 is for using resource pools to transmit and receive reference signals, and determining position information based on measured reference signals. Other flows are possible, e.g., with one or more stages shown omitted, one or more stages added, and/or one or more stages shown altered. For example, sub-stage 1913 may be omitted, e.g., for mode 2 sidelink operation. As another example, stages 1930, 1940, 1950 may be omitted if PRS are not transmitted and measured at stage 1920, e.g., one or more other types of reference signals are transmitted and measured instead of PRS. Still other alterations of the flow; 1900 may be implemented.

At stage 1910, UEs 1901, 1902 (which are examples of the UE 500) obtain SL configurations. For example, at sub-stages 1911, 1912, each of the UEs 1901, 1902 retrieve SL configurations, e.g., of SL resource pools, from the memory 530 of the respective UE 1901, 1902 for mode 2 operation (or as default configurations for mode 1 operation that may be replaced by configurations provided by the network entity 600). For example, the SL unit 550 of each of the UEs 1901, 1902 may retrieve the resource pool configurations 1033 that include resources designated for RS transfer, e.g., PRS transfer for use in determining position estimates of UEs, and/or may retrieve the data resource pool configurations 1333 and the reference signal resource pool configurations 1350.

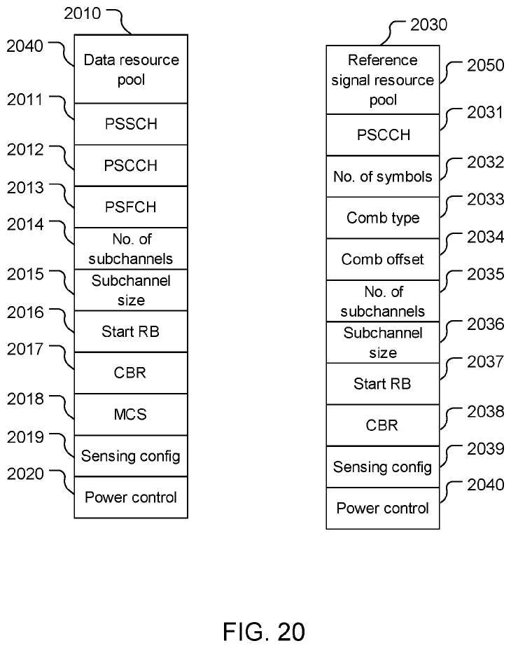

At sub-stage 1913, the network entity 600, e.g., the SL configuration unit 650, may determine the SL configurations. For example, the TRP 300 and the server 400 may communicate to determine one or more SL configurations and the network entity 600 may transmit the one or more SL configurations to the UEs 1901, 1902 in SL configuration messages 1915, 1916, respectively. Referring also to FIG. 20, a control/data resource pool configuration 2010 is an example of one of the SL configurations for a data resource pool and a reference signal resource pool configuration 2030 is an example of one of the SL configurations for a reference signal resource pool. The configurations 2010, 2030 provide separate configurations, with respective sets of configuration parameters for control/data and reference signals, respectively. The configuration 2010 may include an explicit indication 2050 that the configuration is for data or the purpose of the configuration 2010 may be implicit, e.g., based on being provided in a portion of a message dedicated to including the resource pool configuration for data. The configuration 2030 may include an explicit indication 2050 that the configuration is for reference signals or the purpose of the configuration 2030 may be implicit, e.g., based on being provided in a portion of a message dedicated to including the resource pool configuration for reference signals. The configuration 2030 may be for a specific type of reference signal, e.g., PRS, and the purpose of the configuration 2030 may be explicitly or implicitly indicated. As shown, the control/data resource pool configuration 2010 includes a PSSCH configuration field 2011, a PSCCH configuration field 2012, a PSFCH configuration field 2013, a number of subchannels field 2014, a subchannel size field 2015, a start RB field 2016, a CBR field 2017, an MCS field 2018, a sensing configuration field 2019, and a power control field 2020. The fields 2011-2013 indicate configurations of the PSSCH, PSCCH, and PSFCH, respectively, e.g., including information such as information included in the configuration 2030. The reference signal resource pool configuration 2030 includes a PSCCH field 2031, a number of symbols field 2032, a comb type field 2033, a comb offset field 2034, a number of subchannels field 2035, a subchannel size field 2036, a start RB field 2037, a CBR field 2038, a sensing configuration field 2039, and a power control field 2040. The configurations 2010, 2030 are examples of the SL configurations retrieved by the UEs 1901, 1902 at sub-stages 1911, 1912.

The network entity 600 transmits the SL configuration messages 1915, 1916 to the UEs 1901, 1902 for mode 1 operation. The SL configuration messages 1915, 1916 may indicate the purpose(s) for resource pools in the SL configuration messages 1915, 1916, e.g., for data or for reference signals. The UEs 1901, 1902 may store the SL configuration(s) of the SL configuration messages 1915, 1916, e.g., overriding any default SL configurations, for use in transmitting and/or receiving SL signals, e.g., data signals, RS, measurement reports, etc. Sub-stage 1913 may be omitted, e.g., for mode 2 operation. Alternatively, sub-stage 1913 may be performed before the UEs 1901, 1902 leave the range of the network entity 600 and the SL configuration of the SL configuration messages 1915, 1916 may be used by the UEs 1901, 1902 for mode 2 operation after leaving the range of the network entity 600.

At stage 1920, sidelink messages are transmitted, decoded or measured as appropriate, and one or more measurements possibly reported. The UE 1901 transmits a sidelink configuration message 1921 indicating the SL configurations for data resource pools and reference signal resource pools (e.g., the SL configurations or coded indications of the SL configurations that the UE 1902 has stored). The UE 1901 transmits one or more sidelink data/RS messages 1922 that may contain data (using one or more of the resource pool configurations 1033 or one or more of the data resource pool configurations 1333) and/or a reference signal (using one or more of the resource pool configurations 1033 or one or more of the reference signal resource pool configurations 1350). Each of the SL data/RS messages, when containing RS, may contain single-stage or multi-stage (e.g., two-stage) control information for processing of a reference signal of the sidelink data/RS message 1922.

The SL configuration messages 1915, 1916 may allocate resources for the control information and may indicate that one or more resources are allocated in the control/data resource pool for control information to direct a recipient of the control information to one or more resources in the reference signal resource pool. For example, the network entity 600 (e.g., the SL configuration unit 650) may indicate, e.g., in the PSCCH field 2031 one or more resources that are to be used for control information indicating one or more resources in the reference signal resource pool for RS.

At sub-stage 1923, the UE 1902 measures the reference signal transmitted using the reference signal resource pool in the sidelink data/RS message 1922. For RS in one of the resource pool configurations 1033, the UE 1902 reads the SCI-1 signal 1110, which points to the resource location of the SCI-2 signal 1120. The UE 1902 decodes the SCI-2 signal 1120 (e.g., by retrieving an appropriate scrambling code from the memory 530 and using the scrambling code to descramble the SCI-2 signal 1120), which points to the resource location of the RS, e.g., the PRS 1130. The UE 1902 measures the RS at the resource location pointed to by the SCI-2 signal 1120. For RS in one of the reference signal resource pool configurations 1350, and two-stage control information for locating the RS, the UE 1902 reads the SCI-1 signal 1410, which points to the resource location of the SCI-2 signal 1420. The UE 1902 decodes the SCI-2 signal 1420 (e.g., by retrieving an appropriate scrambling code from the memory 530 and using the scrambling code to descramble the SCI-2 signal 1420), which points to the resource location of the RS, e.g., the PRS 1430. The UE 1902 measures the RS at the resource location pointed to by the SCI-2 signal 1420. For RS in one of the reference signal resource pool configurations 1350, and single-stage control information for locating the RS, the UE 1902 reads (possibly using an appropriate scrambling code) the control information, e.g., the SS-SCI signal 1710, which points to the RS, e.g., the PRS 1720. The UE 1902 measures the RS at the resource location pointed to by the SS-SCI signal 1710. The UE 1902 may transmit a measurement report 1924 to the UE 1901 indicating one or more measurement values determined by the UE 1902 for the measured RS.

At stages 1930, 1940 the UEs 1901, 1902 may determine position information. For example, the UEs 1901, 1902 may determine PRS measurements, one or more ranges to one or more other entities (e.g., anchor UE(s), TRP(s)), and/or position estimates for the UEs 1901, 1902, respectively. The UEs 1901, 1902 may transmit position information 1931, 1941 to the network entity 600, with the position information 1931, 1941 including some or all of the position information determined by the UEs 1901, 1902, respectively.

At stage 1950, the network entity 600 may determine position information. For example, the network entity 600 may use some or all of the position information 1931, 1941 to determine a position estimate for the UE 1901 and/or the UE 1902.

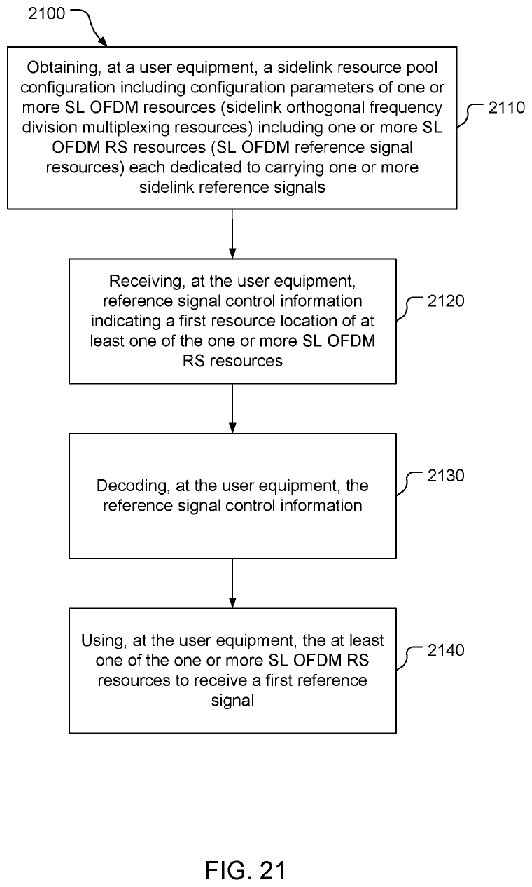

Referring to FIG. 21, with further reference to FIGS. 1-20, a reference signal receiving method 2100 includes the stages shown. The method 2100 is, however, an example and not limiting. The method 2100 may be altered, e.g., by having stages added, removed, rearranged, combined, performed concurrently, and/or having single stages split into multiple stages.

At stage 2110, the method 2100 includes obtaining, at a user equipment, a sidelink resource pool configuration including configuration parameters of one or more SL OFDM resources (sidelink orthogonal frequency division multiplexing resources) including one or more SL OFDM RS resources (SL OFDM reference signal resources) each dedicated to carrying one or more sidelink reference signals. For example, at sub-stage 1912, the processor 510 of the UE 1902 may retrieve, from the memory 530, one or more of the resource pool configurations 1035, that includes configuration information for data and for reference signals, and/or one or more of the resource pool configurations 1352 dedicated to reference signals. In either case, the SL RP configuration includes parameters indicating one or more SL OFDM RS resources. As another example, the UE 1902 may receive the SL RP configuration from the UE 1901 in the sidelink configuration message 1921 and/or from the network entity 600 in the SL configuration message 1916. The processor 510, possibly in combination with the memory 530, possibly in combination with the transceiver 520 (e.g., the wireless receiver 244 and the antenna 246) may comprise means for obtaining the sidelink resource pool configuration.

At stage 2120, the method 2100 includes receiving, at the user equipment, reference signal control information indicating a first resource location of at least one of the one or more SL OFDM RS resources. For example, at stage 1920 the UE 1902 receives control information (e.g., single-stage or two-stage control information) pointing to the resource location of one or more SL OFDM RS resources. The processor 510, possibly in combination with the memory 530, in combination with the transceiver 520 (e.g., the wireless receiver 244 and the antenna 246) may comprise means for receiving the reference signal control information.

At stage 2130, the method 2100 includes decoding, at the user equipment, the reference signal control information. For example, in the case of two-stage control information corresponding to a resource pool for data and RS or a resource pool dedicated to RS, the UE 1902 reads the first-stage control information, e.g., the SCI-1 signal 1110 or the SCI-1 signal 1410, to determine the resource location of the second-stage control information, e.g., the SCI-2 signal 1120 or the SCI-2 signal 1420. The UE 1902, knowing that the resource(s) indicated by the first-stage control information is (are) for RS, the UE 1902 decodes second-stage control information based on a known format for the second-stage control information and/or other decoding information (e.g., a scrambling code). As another example, the UE 1902 may receive single-stage control information, e.g., the SS-SCI signal 1710, and decode this information based on a known format for the single-stage control information and/or other decoding information (e.g., a scrambling code). The processor 510, possibly in combination with the memory 530, may comprise means for decoding the reference signal control information.

At stage 2140, the method 2100 includes using, at the user equipment, the at least one of the one or more SL OFDM RS resources to receive a first reference signal. For example, the UE 1902 listens for RS at the resource location pointed to by the reference signal control information. The processor 510, possibly in combination with the memory 530, in combination with the transceiver 520 (e.g., the wireless receiver 244 and the antenna 246) may comprise means for using the at least one of the one or more SL OFDM Rs resources to receive the first RS. In this way, the UE 1902 is able to receive a reference signal based on resources, of a resource pool, dedicated for RS which avoids having two resource pools. This may result in lower overhead, shorter wake-up periods, and/or less SCI monitoring (which may save power and/or processing effort)

Implementations of the method 2100 may include one or more of the following features. In an example implementation, decoding the reference signal control information comprises decoding the reference signal control information using first decoding information associated with the one or more SL OFDM RS resources. For example, the UE 1902 may decode second-stage control information, or single-stage control information, based on one or more expected formats. In a further example implementation, the one or more SL OFDM resources include one or more SL OFDM data resources each dedicated to carrying data or communication information, the reference signal control information is second-stage control information, and wherein the reference signal receiving method further comprises: receiving, at the user equipment, first-stage control information indicating a second resource location of the reference signal control information without indicating reference signal configuration information; and decoding, at the user equipment, the first-stage control information. For example, the SL RP configuration is one of the resource pool configurations 1035 for data and RS, and the UE 1902 receives two-stage control information, with the first-stage control information being of a legacy format, without SL RS configuration information (e.g., number of symbols, comb type, comb-offset), and decodes the first-stage control information. The processor 510, possibly in combination with the memory 530, in combination with the transceiver 520 (e.g., the wireless receiver 244 and the antenna 246) may comprise means for receiving the first-stage control information and processor 510, possibly in combination with the memory 530, may comprise means for decoding the first-stage control information. In another further example implementation, the sidelink resource pool configuration is a first sidelink resource pool configuration, the configuration parameters of one or more SL OFDM resources are first configuration parameters, and obtaining the sidelink resource pool configuration comprises obtaining a second sidelink resource pool configuration, separate from the first sidelink resource pool configuration, including second configuration parameters of one or more SL OFDM data resources each dedicated to carrying data or communication information. For example, the UE 1902 obtains one or more of the resource pool configurations 1335, dedicated to data, and one or more of the resource pool configurations 1352, dedicated to RS. In a further example implementation, the reference signal control information is second-stage control information, and the reference signal receiving method further comprises: receiving, at the user equipment, first-stage control information indicating a second resource location of the reference signal control information without indicating reference signal configuration information; and decoding, at the user equipment, the first-stage control information. For example, the UE 1902 receives two-stage control information within one or more resources according to the resource pool configuration 1352, with the first-stage control information being of a legacy format, without SL RS configuration information (e.g., number of symbols, comb type, comb-offset), and decodes the first-stage control information. The processor 510, possibly in combination with the memory 530, in combination with the transceiver 520 (e.g., the wireless receiver 244 and the antenna 246) may comprise means for receiving the first-stage control information and processor 510, possibly in combination with the memory 530, may comprise means for decoding the first-stage control information. In another further example implementation, the reference signal control information is second-stage control information, and the reference signal receiving method further comprises: receiving, at the user equipment, first-stage control information indicating a second resource location of the reference signal control information and indicating reference signal configuration information; and decoding, at the user equipment, the first-stage control information including the reference signal configuration information. For example, the UE 1902 receives two-stage control information within one or more resources according to the resource pool configuration 1352, with the first-stage control information being of a new format (e.g., the SCI-1 format 1600 including the SL-RS configuration information 1610 (e.g., number of symbols, comb type, comb-offset)), and decodes the first-stage control information. The processor 510, possibly in combination with the memory 530, in combination with the transceiver 520 (e.g., the wireless receiver 244 and the antenna 246) may comprise means for receiving the first-stage control information and processor 510, possibly in combination with the memory 530, may comprise means for decoding the first-stage control information. In another further example implementation, the reference signal control information is a single-stage control information message. For example, the UE 1902 may receive the SS-SCI signal 1710 as part of the sidelink data/RS message 1922. The UE 1902 may decode the single-stage control information to determine the resource location of RS to be measured. In another further example implementation, the first sidelink resource pool configuration has a different subcarrier spacing, or different bandwidth, or different location in frequency, or any combination thereof, than the second sidelink resource pool configuration.

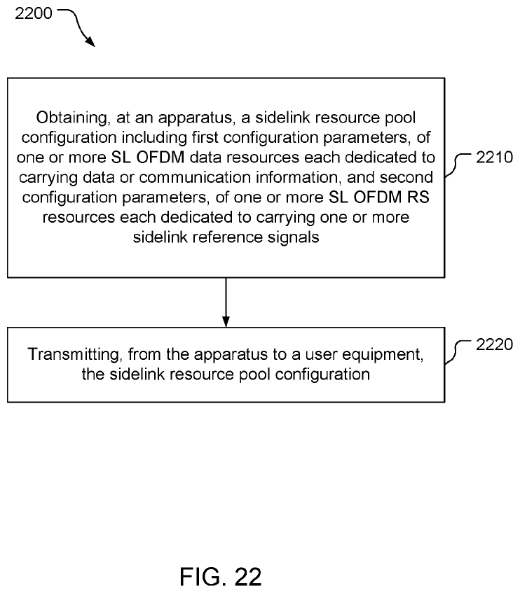

Referring to FIG. 22, with further reference to FIGS. 1-20, a resource pool allocation method 2200 includes the stages shown. The method 2200 is, however, an example and not limiting. The method 2200 may be altered, e.g., by having stages added, removed, rearranged, combined, performed concurrently, and/or having single stages split into multiple stages.

At stage 2210, the method 2200 includes obtaining, at an apparatus, a sidelink resource pool configuration including first configuration parameters, of one or more SL OFDM data resources each dedicated to carrying data or communication information, and second configuration parameters, of one or more SL OFDM RS resources each dedicated to carrying one or more sidelink reference signals. For example, at sub-stage 1911, the processor 510 of the UE 1901 may retrieve, from the memory 530, one or more of the resource pool configurations 1035, that includes configuration information for data and for reference signals, one or more of the resource pool configurations 1335 dedicated to data and one or more of the resource pool configurations 1352 dedicated to reference signals. In either case, the SL RP configuration includes parameters indicating one or more SL OFDM RS resources. As another example, the UE 1901 may receive the SL RP configuration from the network entity 600 in the SL configuration message 1915. As another example, at sub-stage 1913, the network entity 600 may retrieve the SL RP configuration from the memory 630 or generate the SL RP configuration. The processor 510, possibly in combination with the memory 530, possibly in combination with the transceiver 520 (e.g., the wireless receiver 244 and the antenna 246) may comprise means for obtaining the sidelink resource pool configuration. Also or alternatively, the processor 610, possibly in combination with the memory 630, may comprise means for obtaining the sidelink resource pool configuration.

At stage 2220, the method 2200 includes transmitting, from the apparatus to a user equipment, the sidelink resource pool configuration. For example, at stage 1920, the UE 1902 may transmit the SL RP configuration to the UE 1902 in the SL configuration message 1921. As another example, at stage 1910, the network entity 600 may transmit the SL RP configuration to the UE 1902 in the SL configuration message 1916. The processor 510, possibly in combination with the memory 530, possibly in combination with the transceiver 520 (e.g., the wireless transmitter 242 and the antenna 246) may comprise means for transmitting the SL RP configuration. Also or alternatively, the processor 610, possibly in combination with the memory 630, possibly in combination with the transceiver 620 (e.g., the wireless transmitter 342 and the antenna 346 and/or the wired transmitter 452 and/or the wireless transmitter 442 and the antenna 446) may comprise means for transmitting the SL RP configuration.

Implementations of the method 2200 may include one or more of the following features. In an example implementation, the first configuration parameters and the second configuration parameters include a plurality of shared configuration parameters. The SL RP configuration may, for example, be the resource pool configuration 1035, with resources for data and resources for RS sharing parameters of the BWP generic configuration parameter collection 1032. In a further example implementation, the plurality of shared configuration parameters comprise subcarrier spacing, bandwidth, frequency domain location, and time domain location.

Also or alternatively, implementations of the method 2200 may include one or more of the following features. In an example implementation, the first configuration parameters are separate from the second configuration parameters. For example, the SL RP configuration may include the resource pool configuration 1335, dedicated to data, and the resource pool configuration 1352, dedicated to RS, with parameters for the resource pool configuration 1335 being separate from parameters of the resource pool configuration 1352 (even if one or more of the parameters of the resource pool configurations 1335, 1352 has(have) the same value(s)). In a further example implementation, the first configuration parameters include a first subcarrier spacing, a first location in frequency, and a first bandwidth, and wherein the second configuration parameters include a second subcarrier spacing, a second location in frequency, and a second bandwidth, where: the second subcarrier spacing is different from the first subcarrier spacing; or the second location in frequency is different from the first location in frequency; or the second bandwidth is different from the first bandwidth; or any combination thereof. For example, the value(s) of one or more parameters of the BWP generic configuration parameter collection 1332 (shared by multiple ones of the resource pool configurations 1335) and the reference signal resource pool configurations 1350 (shared by multiple ones of the resource pool configurations 1352) may be different. In another further example implementation, the first configuration parameters include one or more first channel sensing parameter values, one or more first channel busy ratio parameter values, and one or more first power control parameter values, and the second configuration parameters include one or more second channel sensing parameter values different from the one or more first channel sensing parameter values, one or more second channel busy ratio parameter values different from the one or more first channel busy ratio parameter values, and one or more second power control parameter values that are different from the one or more first power control parameter values. For example, one or more of the value(s) of one or more similar parameters of the resource pool configurations 1335, 1352 may be different.

Also or alternatively, implementations of the method 2200 may include one or more of the following features. In an example implementation, the user equipment is a second user equipment and the apparatus is a first user equipment, and the resource pool allocation method 2200 further comprises: encoding, at the first user equipment, second control information with second coding information associated with the one or more SL OFDM RS resources to produce encoded second control information; obtaining, at the first user equipment, first control information indicating a resource location of the encoded second control information without indicating a reference signal configuration; and transmitting, from the first user equipment to the second user equipment, the first control information and the encoded second control information. For example, the UE 1901 may encode second-stage control information (e.g., the SCI-2 signal 1120 or the SCI-2 signal 1420) with coding information (e.g., a desired format and a scrambling code), obtain (e.g., retrieve from the memory 530 or determine) first-stage control information (e.g., the SCI-1 signal 1110 or the SCI-1 signal 1410 (in a legacy format or a new format)), and transmit the first-stage control information and the second-stage control information to the UE 1902. In this way, the UE 1901 may provide control information for RS that may be decoded by a UE that is configured to find and measure RS from a resource pool that may convey RS (e.g., either completely or partially being dedicated to RS). The processor 510, possibly in combination with the memory 530, or the processor 610, possibly in combination with the memory 630, may comprise means for encoding second control information and means for obtaining first control information. The processor 510, possibly in combination with the memory 530, possibly in combination with the transceiver 520 (e.g., the wireless transmitter 242 and the antenna 246) may comprise means for transmitting the first and second control information. Also or alternatively, the processor 610, possibly in combination with the memory 630, possibly in combination with the transceiver 620 (e.g., the wireless transmitter 342 and the antenna 346 and/or the wired transmitter 452 and/or the wireless transmitter 442 and the antenna 446) may comprise means for transmitting the first and second control information. In another example implementation, the second configuration parameters include a first subset of the second configuration parameters corresponding to a first subset of the one or more SL OFDM RS resources for base-station-scheduled sidelink transmissions, and wherein the second configuration parameters include a second subset of the second configuration parameters corresponding to a second subset of the one or more SL OFDM RS resources for user-equipment-scheduled sidelink transmissions. For example, the SL RP configuration is the resource pool configuration 1035 including parameters for data resources and parameters for RS resources. In another example implementation, the user equipment is a second user equipment and the apparatus is a first user equipment, the first configuration parameters are separate from the second configuration parameters, and the resource pool allocation method 2200 further comprises: obtaining, at the first user equipment, single-stage control information indicating a resource location of the one or more SL OFDM RS resources; and transmitting, from the first user equipment to the second user equipment, the single-stage control information. For example, the UE 1901 may obtain (e.g., retrieve from the memory 530 or determine) single-stage control information (e.g., the SS-SCI signal 1710) and transmit the single-stage control information to the UE 1902 for use in measuring RS. The processor 510, possibly in combination with the memory 530, or the processor 610, possibly in combination with the memory 630, may comprise means for obtaining single-stage control information. The processor 510, possibly in combination with the memory 530, possibly in combination with the transceiver 520 (e.g., the wireless transmitter 242 and the antenna 246) may comprise means for transmitting the single-stage control information. Also or alternatively, the processor 610, possibly in combination with the memory 630, possibly in combination with the transceiver 620 (e.g., the wireless transmitter 342 and the antenna 346 and/or the wired transmitter 452 and/or the wireless transmitter 442 and the antenna 446) may comprise means for transmitting the single-stage control information.

### IMPLEMENTATION EXAMPLES

Implementation examples are provided in the following numbered clauses.

Clause 1. A user equipment comprising:
a transceiver;
a memory; and
a processor, communicatively coupled to the memory and the transceiver, that is:
   configured to obtain a sidelink resource pool configuration including configuration parameters of one or more SL OFDM resources (sidelink orthogonal frequency division multiplexing resources) including one or more SL OFDM RS resources (SL OFDM reference signal resources) each dedicated to carrying one or more sidelink reference signals;
   configured to receive, via the transceiver, reference signal control information indicating a first resource location of at least one of the one or more SL OFDM RS resources;
   configured to decode the reference signal control information; and
   configured to use the at least one of the one or more SL OFDM RS resources to receive a first reference signal via the transceiver.

Clause 2. The user equipment of clause 1, wherein the processor is configured to decode the reference signal control information using first decoding information associated with the one or more SL OFDM RS resources.

Clause 3. The user equipment of clause 2, wherein the one or more SL OFDM resources include one or more SL OFDM data resources each dedicated to carrying data or communication information, the reference signal control information is second-stage control information, and wherein the processor is configured to:
receive, via the transceiver, first-stage control information indicating a second resource location of the reference signal control information without indicating reference signal configuration information; and
decode the first-stage control information.

Clause 4. The user equipment of clause 2, wherein the sidelink resource pool configuration is a first sidelink resource pool configuration, the configuration parameters of one or more SL OFDM resources are first configuration parameters, and the processor is configured to obtain a second sidelink resource pool configuration, separate from the first sidelink resource pool configuration, including second configuration parameters of one or more SL OFDM data resources each dedicated to carrying data or communication information.

Clause 5. The user equipment of clause 4, wherein the reference signal control information is second-stage control information, and the processor is configured to:
receive, via the transceiver, first-stage control information indicating a second resource location of the reference signal control information without indicating reference signal configuration information; and
decode the first-stage control information.

Clause 6. The user equipment of clause 4, wherein the reference signal control information is second-stage control information, and the processor is configured to:
receive, via the transceiver, first-stage control information indicating a second resource location of the reference signal control information and indicating reference signal configuration information; and
decode the first-stage control information including the reference signal configuration information.

Clause 7. The user equipment of clause 4, wherein the reference signal control information is a single-stage control information message.

Clause 8. The user equipment of clause 4, wherein the first sidelink resource pool configuration has a different subcarrier spacing, or different bandwidth, or different location in frequency, or any combination thereof, than the second sidelink resource pool configuration.

Clause 9. A reference signal receiving method comprising:
obtaining, at a user equipment, a sidelink resource pool configuration including configuration parameters of one or more SL OFDM resources (sidelink orthogonal frequency division multiplexing resources) including one or more SL OFDM RS resources (SL OFDM reference signal resources) each dedicated to carrying one or more sidelink reference signals;
receiving, at the user equipment, reference signal control information indicating a first resource location of at least one of the one or more SL OFDM RS resources;
decoding, at the user equipment, the reference signal control information; and
using, at the user equipment, the at least one of the one or more SL OFDM RS resources to receive a first reference signal.

Clause 10. The reference signal receiving method of clause 9, wherein decoding the reference signal control information comprises decoding the reference signal control information using first decoding information associated with the one or more SL OFDM RS resources.

Clause 11. The reference signal receiving method of clause 10, wherein the one or more SL OFDM resources include one or more SL OFDM data resources each dedicated to carrying data or communication information, the reference signal control information is second-stage control information, and wherein the reference signal receiving method further comprises:
receiving, at the user equipment, first-stage control information indicating a second resource location of the reference signal control information without indicating reference signal configuration information; and
decoding, at the user equipment, the first-stage control information.

Clause 12. The reference signal receiving method of clause 10, wherein the sidelink resource pool configuration is a first sidelink resource pool configuration, the configuration parameters of one or more SL OFDM resources are first configuration parameters, and obtaining the sidelink resource pool configuration comprises obtaining a second sidelink resource pool configuration, separate from the first sidelink resource pool configuration, including second configuration parameters of one or more SL OFDM data resources each dedicated to carrying data or communication information.

Clause 13. The reference signal receiving method of clause 12, wherein the reference signal control information is second-stage control information, and the reference signal receiving method further comprises:
receiving, at the user equipment, first-stage control information indicating a second resource location of the reference signal control information without indicating reference signal configuration information; and
decoding, at the user equipment, the first-stage control information.

Clause 14. The reference signal receiving method of clause 12, wherein the reference signal control information is second-stage control information, and the reference signal receiving method further comprises:
receiving, at the user equipment, first-stage control information indicating a second resource location of the reference signal control information and indicating reference signal configuration information; and
decoding, at the user equipment, the first-stage control information including the reference signal configuration information.

Clause 15. The reference signal receiving method of clause 12, wherein the reference signal control information is a single-stage control information message.

Clause 16. The reference signal receiving method of clause 12, wherein the first sidelink resource pool configuration has a different subcarrier spacing, or different bandwidth, or different location in frequency, or any combination thereof, than the second sidelink resource pool configuration.

Clause 17. A user equipment comprising:
means for obtaining a sidelink resource pool configuration including configuration parameters of one or more SL OFDM resources (sidelink orthogonal frequency division multiplexing resources) including one or more SL OFDM RS resources (SL OFDM reference signal resources) each dedicated to carrying one or more sidelink reference signals;
means for receiving reference signal control information indicating a first resource location of at least one of the one or more SL OFDM RS resources;
means for decoding the reference signal control information; and
means for using the at least one of the one or more SL OFDM RS resources to receive a first reference signal.

Clause 18. The user equipment of clause 17, wherein the means for decoding the reference signal control information comprise means for decoding the reference signal control information using first decoding information associated with the one or more SL OFDM RS resources.

Clause 19. The user equipment of clause 18, wherein the one or more SL OFDM resources include one or more SL OFDM data resources each dedicated to carrying data or communication information, the reference signal control information is second-stage control information, and wherein the user equipment further comprises:
means for receiving first-stage control information indicating a second resource location of the reference signal control information without indicating reference signal configuration information; and
means for decoding the first-stage control information.

Clause 20. The user equipment of clause 18, wherein the sidelink resource pool configuration is a first sidelink resource pool configuration, the configuration parameters of one or more SL OFDM resources are first configuration parameters, and the means for obtaining the sidelink resource pool configuration comprise means for obtaining a second sidelink resource pool configuration, separate from the first sidelink resource pool configuration, including second configuration parameters of one or more SL OFDM data resources each dedicated to carrying data or communication information.

Clause 21. The user equipment of clause 20, wherein the reference signal control information is second-stage control information, and the user equipment further comprises:
means for receiving first-stage control information indicating a second resource location of the reference signal control information without indicating reference signal configuration information; and
means for decoding the first-stage control information.

Clause 22. The user equipment of clause 20, wherein the reference signal control information is second-stage control information, and the user equipment further comprises:
means for receiving first-stage control information indicating a second resource location of the reference signal control information and indicating reference signal configuration information; and
means for decoding the first-stage control information including the reference signal configuration information.

Clause 23. The user equipment of clause 20, wherein the reference signal control information is a single-stage control information message.

Clause 24. The user equipment of clause 20, wherein the first sidelink resource pool configuration has a different subcarrier spacing, or different bandwidth, or different location in frequency, or any combination thereof, than the second sidelink resource pool configuration.

Clause 25. A non-transitory, processor-readable storage medium comprising processor-readable instructions to cause a processor of a user equipment to:
obtain a sidelink resource pool configuration including configuration parameters of one or more SL OFDM resources (sidelink orthogonal frequency division multiplexing resources) including one or more SL OFDM RS resources (SL OFDM reference signal resources) each dedicated to carrying one or more sidelink reference signals;
receive reference signal control information indicating a first resource location of at least one of the one or more SL OFDM RS resources;
decode the reference signal control information; and
use the at least one of the one or more SL OFDM RS resources to receive a first reference signal.

Clause 26. The non-transitory, processor-readable storage medium of clause 25, wherein the processor-readable instructions to cause the processor to decode the reference signal control information comprise processor-readable instructions to cause the processor to decode the reference signal control information using first decoding information associated with the one or more SL OFDM RS resources.

Clause 27. The non-transitory, processor-readable storage medium of clause 26, wherein the one or more SL OFDM resources include one or more SL OFDM data resources each dedicated to carrying data or communication information, the reference signal control information is second-stage control information, and wherein the non-transitory, processor-readable storage medium further comprises processor-readable instructions to cause the processor to:
receive first-stage control information indicating a second resource location of the reference signal control information without indicating reference signal configuration information; and
decode the first-stage control information.

Clause 28. The non-transitory, processor-readable storage medium of clause 26, wherein the sidelink resource pool configuration is a first sidelink resource pool configuration, the configuration parameters of one or more SL OFDM resources are first configuration parameters, and the processor-readable instructions to cause the processor to obtain the sidelink resource pool configuration comprise processor-readable instructions to cause the processor to obtain a second sidelink resource pool configuration, separate from the first sidelink resource pool configuration, including second configuration parameters of one or more SL OFDM data resources each dedicated to carrying data or communication information.

Clause 29. The non-transitory, processor-readable storage medium of clause 28, wherein the reference signal control information is second-stage control information, and the non-transitory, processor-readable storage medium further comprises processor-readable instructions to cause the processor to:
receive first-stage control information indicating a second resource location of the reference signal control information without indicating reference signal configuration information; and
decode the first-stage control information.

Clause 30. The non-transitory, processor-readable storage medium of clause 28, wherein the reference signal control information is second-stage control information, and the non-transitory, processor-readable storage medium further comprises processor-readable instructions to cause the processor to:
receive first-stage control information indicating a second resource location of the reference signal control information and indicating reference signal configuration information; and
decode the first-stage control information including the reference signal configuration information.

Clause 31. The non-transitory, processor-readable storage medium of clause 28, wherein the reference signal control information is a single-stage control information message.

Clause 32. The non-transitory, processor-readable storage medium of clause 28, wherein the first sidelink resource pool configuration has a different subcarrier spacing, or different bandwidth, or different location in frequency, or any combination thereof, than the second sidelink resource pool configuration.

Clause 33. An apparatus comprising:
a transceiver;
a memory; and
a processor, communicatively coupled to the memory and the transceiver, configured to:
   obtain a sidelink resource pool configuration including first configuration parameters, of one or more SL OFDM data resources (sidelink orthogonal frequency division multiplexing data resources) each dedicated to carrying data or communication information, and second configuration parameters, of one or more SL OFDM RS resources (SL OFDM reference signal resources) each dedicated to carrying one or more sidelink reference signals; and
   transmit, via the transceiver, the sidelink resource pool configuration.

Clause 34. The apparatus of clause 33, wherein the first configuration parameters and the second configuration parameters include a plurality of shared configuration parameters.

Clause 35. The apparatus of clause 34, wherein the plurality of shared configuration parameters comprise subcarrier spacing, bandwidth, frequency domain location, and time domain location.

Clause 36. The apparatus of clause 33, wherein the first configuration parameters are separate from the second configuration parameters.

Clause 37. The apparatus of clause 36, wherein the first configuration parameters include a first subcarrier spacing, a first location in frequency, and a first bandwidth, and wherein the second configuration parameters include a second subcarrier spacing, a second location in frequency, and a second bandwidth, wherein:
the second subcarrier spacing is different from the first subcarrier spacing; or
the second location in frequency is different from the first location in frequency; or
the second bandwidth is different from the first bandwidth; or
any combination thereof.

Clause 38. The apparatus of clause 36, wherein the first configuration parameters include one or more first channel sensing parameter values, one or more first channel busy ratio parameter values, and one or more first power control parameter values, and the second configuration parameters include one or more second channel sensing parameter values different from the one or more first channel sensing parameter values, one or more second channel busy ratio parameter values different from the one or more first channel busy ratio parameter values, and one or more second power control parameter values that are different from the one or more first power control parameter values.

Clause 39. The apparatus of clause 33, wherein the apparatus is a first user equipment, and the processor is configured to:
encode second control information with second coding information associated with the one or more SL OFDM RS resources to produce encoded second control information;
obtain first control information indicating a resource location of the encoded second control information without indicating a reference signal configuration; and
transmit, via the transceiver, the first control information and the encoded second control information to a second user equipment.

Clause 40. The apparatus of clause 33, wherein the second configuration parameters include a first subset of the second configuration parameters corresponding to a first subset of the one or more SL OFDM RS resources for base-station-scheduled sidelink transmissions, and wherein the second configuration parameters include a second subset of the second configuration parameters corresponding to a second subset of the one or more SL OFDM RS resources for user-equipment-scheduled sidelink transmissions.

Clause 41. The apparatus of clause 33, wherein the apparatus is a first user equipment, the first configuration parameters are separate from the second configuration parameters, and the processor is configured to:
obtain single-stage control information indicating a resource location of the one or more SL OFDM RS resources; and
transmit, via the transceiver, the single-stage control information to a second user equipment.

Clause 42. A resource pool allocation method comprising:
obtaining, at an apparatus, a sidelink resource pool configuration including first configuration parameters, of one or more SL OFDM data resources (sidelink orthogonal frequency division multiplexing data resources) each dedicated to carrying data or communication information, and second configuration parameters, of one or more SL OFDM RS resources (SL OFDM reference signal resources) each dedicated to carrying one or more sidelink reference signals; and
transmitting, from the apparatus to a user equipment, the sidelink resource pool configuration.

Clause 43. The resource pool allocation method of clause 42, wherein the first configuration parameters and the second configuration parameters include a plurality of shared configuration parameters.

Clause 44. The resource pool allocation method of clause 43, wherein the plurality of shared configuration parameters comprise subcarrier spacing, bandwidth, frequency domain location, and time domain location.

Clause 45. The resource pool allocation method of clause 42, wherein the first configuration parameters are separate from the second configuration parameters.

Clause 46. The resource pool allocation method of clause 45, wherein the first configuration parameters include a first subcarrier spacing, a first location in frequency, and a first bandwidth, and wherein the second configuration parameters include a second subcarrier spacing, a second location in frequency, and a second bandwidth, wherein:
the second subcarrier spacing is different from the first subcarrier spacing; or
the second location in frequency is different from the first location in frequency; or
the second bandwidth is different from the first bandwidth; or
any combination thereof.

Clause 47. The resource pool allocation method of clause 45, wherein the first configuration parameters include one or more first channel sensing parameter values, one or more first channel busy ratio parameter values, and one or more first power control parameter values, and the second configuration parameters include one or more second channel sensing parameter values different from the one or more first channel sensing parameter values, one or more second channel busy ratio parameter values different from the one or more first channel busy ratio parameter values, and one or more second power control parameter values that are different from the one or more first power control parameter values.

Clause 48. The resource pool allocation method of clause 42, wherein the user equipment is a second user equipment and the apparatus is a first user equipment, and the resource pool allocation method further comprises:
encoding, at the first user equipment, second control information with second coding information associated with the one or more SL OFDM RS resources to produce encoded second control information:
obtaining, at the first user equipment, first control information indicating a resource location of the encoded second control information without indicating a reference signal configuration; and
transmitting, from the first user equipment to the second user equipment, the first control information and the encoded second control information.

Clause 49. The resource pool allocation method of clause 42, wherein the second configuration parameters include a first subset of the second configuration parameters corresponding to a first subset of the one or more SL OFDM RS resources for base-station-scheduled sidelink transmissions, and wherein the second configuration parameters include a second subset of the second configuration parameters corresponding to a second subset of the one or more SL OFDM RS resources for user-equipment-scheduled sidelink transmissions.

Clause 50. The resource pool allocation method of clause 42, wherein the user equipment is a second user equipment and the apparatus is a first user equipment, the first configuration parameters are separate from the second configuration parameters, and the resource pool allocation method further comprises:
obtaining, at the first user equipment, single-stage control information indicating a resource location of the one or more SL OFDM RS resources; and
transmitting, from the first user equipment to the second user equipment, the single-stage control information.

Clause 51. An apparatus comprising:
means for obtaining a sidelink resource pool configuration including first configuration parameters, of one or more SL OFDM data resources (sidelink orthogonal frequency division multiplexing data resources) each dedicated to carrying data or communication information, and second configuration parameters, of one or more SL OFDM RS resources (SL OFDM reference signal resources) each dedicated to carrying one or more sidelink reference signals; and
means for transmitting, to a user equipment, the sidelink resource pool configuration.

Clause 52. The apparatus of clause 51, wherein the first configuration parameters and the second configuration parameters include a plurality of shared configuration parameters.

Clause 53. The apparatus of clause 52, wherein the plurality of shared configuration parameters comprise subcarrier spacing, bandwidth, frequency domain location, and time domain location.

Clause 54. The apparatus of clause 51, wherein the first configuration parameters are separate from the second configuration parameters.

Clause 55. The apparatus of clause 54, wherein the first configuration parameters include a first subcarrier spacing, a first location in frequency, and a first bandwidth, and wherein the second configuration parameters include a second subcarrier spacing, a second location in frequency, and a second bandwidth, wherein:
the second subcarrier spacing is different from the first subcarrier spacing; or
the second location in frequency is different from the first location in frequency; or
the second bandwidth is different from the first bandwidth; or
any combination thereof.

Clause 56. The apparatus of clause 54, wherein the first configuration parameters include one or more first channel sensing parameter values, one or more first channel busy ratio parameter values, and one or more first power control parameter values, and the second configuration parameters include one or more second channel sensing parameter values different from the one or more first channel sensing parameter values, one or more second channel busy ratio parameter values different from the one or more first channel busy ratio parameter values, and one or more second power control parameter values that are different from the one or more first power control parameter values.

Clause 57. The apparatus of clause 51, wherein the user equipment is a second user equipment and the apparatus is a first user equipment, and the apparatus further comprises:
means for encoding second control information with second coding information associated with the one or more SL OFDM RS resources to produce encoded second control information;
means for obtaining first control information indicating a resource location of the encoded second control information without indicating a reference signal configuration; and
means for transmitting, to the second user equipment, the first control information and the encoded second control information.

Clause 58. The apparatus of clause 51, wherein the second configuration parameters include a first subset of the second configuration parameters corresponding to a first subset of the one or more SL OFDM RS resources for base-station-scheduled sidelink transmissions, and wherein the second configuration parameters include a second subset of the second configuration parameters corresponding to a second subset of the one or more SL OFDM RS resources for user-equipment-scheduled sidelink transmissions.

Clause 59. The apparatus of clause 51, wherein the user equipment is a second user equipment and the apparatus is a first user equipment, the first configuration parameters are separate from the second configuration parameters, and the apparatus further comprises:
means for obtaining single-stage control information indicating a resource location of the one or more SL OFDM RS resources; and
means for transmitting, to the second user equipment, the single-stage control information.

Clause 60. A non-transitory, processor-readable storage medium comprising processor-readable instructions to cause a processor of an apparatus to:
obtain a sidelink resource pool configuration including first configuration parameters, of one or more SL OFDM data resources (sidelink orthogonal frequency division multiplexing data resources) each dedicated to carrying data or communication information, and second configuration parameters, of one or more SL OFDM RS resources (SL OFDM reference signal resources) each dedicated to carrying one or more sidelink reference signals; and
transmit, to a user equipment, the sidelink resource pool configuration.

Clause 61. The non-transitory, processor-readable storage medium of clause 60, wherein the first configuration parameters and the second configuration parameters include a plurality of shared configuration parameters.

Clause 62. The non-transitory, processor-readable storage medium of clause 61, wherein the plurality of shared configuration parameters comprise subcarrier spacing, bandwidth, frequency domain location, and time domain location.

Clause 63. The non-transitory, processor-readable storage medium of clause 60, wherein the first configuration parameters are separate from the second configuration parameters.

Clause 64. The non-transitory, processor-readable storage medium of clause 63, wherein the first configuration parameters include a first subcarrier spacing, a first location in frequency, and a first bandwidth, and wherein the second configuration parameters include a second subcarrier spacing, a second location in frequency, and a second bandwidth, wherein:
the second subcarrier spacing is different from the first subcarrier spacing; or
the second location in frequency is different from the first location in frequency; or
the second bandwidth is different from the first bandwidth; or
any combination thereof.

Clause 65. The non-transitory, processor-readable storage medium of clause 63, wherein the first configuration parameters include one or more first channel sensing parameter values, one or more first channel busy ratio parameter values, and one or more first power control parameter values, and the second configuration parameters include one or more second channel sensing parameter values different from the one or more first channel sensing parameter values, one or more second channel busy ratio parameter values different from the one or more first channel busy ratio parameter values, and one or more second power control parameter values that are different from the one or more first power control parameter values.

Clause 66. The non-transitory, processor-readable storage medium of clause 60, wherein the user equipment is a second user equipment and the apparatus is a first user equipment, and the non-transitory, processor-readable storage medium further comprises processor-readable instructions to cause the processor to:
encode second control information with second coding information associated with the one or more SL OFDM RS resources to produce encoded second control information;
obtain first control information indicating a resource location of the encoded second control information without indicating a reference signal configuration; and
transmit, to the second user equipment, the first control information and the encoded second control information.

Clause 67. The non-transitory, processor-readable storage medium of clause 60, wherein the second configuration parameters include a first subset of the second configuration parameters corresponding to a first subset of the one or more SL OFDM RS resources for base-station-scheduled sidelink transmissions, and wherein the second configuration parameters include a second subset of the second configuration parameters corresponding to a second subset of the one or more SL OFDM RS resources for user-equipment-scheduled sidelink transmissions.

Clause 68. The non-transitory, processor-readable storage medium of clause 60, wherein the user equipment is a second user equipment and the apparatus is a first user equipment, the first configuration parameters are separate from the second configuration parameters, and the non-transitory, processor-readable storage medium further comprises processor-readable instructions to cause the processor to:
obtain single-stage control information indicating a resource location of the one or more SL OFDM RS resources; and
transmit, to the second user equipment, the single-stage control information.

### Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly, but is configured to have at least some communications transmitted wirelessly. Further, the term “wireless communication device,” or similar term, does not require that the functionality of the device is exclusively, or evenly primarily, for communication, or that the device be a mobile device, but indicates that the device includes wireless communication capability (one-way or two-way), e.g., includes at least one radio (each radio being part of a transmitter, receiver, or transceiver) for wireless communication.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A user equipment comprising:
a transceiver;
a memory; and
a processor, communicatively coupled to the memory and the transceiver, that is:
configured to obtain a sidelink resource pool configuration including configuration parameters of one or more SL OFDM resources (sidelink orthogonal frequency division multiplexing resources) including one or more SL OFDM RS resources (SL OFDM reference signal resources) each dedicated to carrying one or more sidelink reference signals;
configured to receive, via the transceiver, reference signal control information indicating a first resource location of at least one of the one or more SL OFDM RS resources;
configured to decode the reference signal control information; and
configured to use the at least one of the one or more SL OFDM RS resources to receive a first reference signal via the transceiver.

2. The user equipment of claim 1, wherein the processor is configured to decode the reference signal control information using first decoding information associated with the one or more SL OFDM RS resources.

3. The user equipment of claim 2, wherein the one or more SL OFDM resources include one or more SL OFDM data resources each dedicated to carrying data or communication information, the reference signal control information is second-stage control information, and wherein the processor is configured to:
receive, via the transceiver, first-stage control information indicating a second resource location of the reference signal control information without indicating reference signal configuration information; and
decode the first-stage control information.

4. The user equipment of claim 2, wherein the sidelink resource pool configuration is a first sidelink resource pool configuration, the configuration parameters of one or more SL OFDM resources are first configuration parameters, and the processor is configured to obtain a second sidelink resource pool configuration, separate from the first sidelink resource pool configuration, including second configuration parameters of one or more SL OFDM data resources each dedicated to carrying data or communication information.

5. The user equipment of claim 4, wherein the reference signal control information is second-stage control information, and the processor is configured to:
receive, via the transceiver, first-stage control information indicating a second resource location of the reference signal control information without indicating reference signal configuration information; and
decode the first-stage control information.

6. The user equipment of claim 4, wherein the reference signal control information is second-stage control information, and the processor is configured to:
receive, via the transceiver, first-stage control information indicating a second resource location of the reference signal control information and indicating reference signal configuration information; and
decode the first-stage control information including the reference signal configuration information.

7. The user equipment of claim 4, wherein the reference signal control information is a single-stage control information message.

8. The user equipment of claim 4, wherein the first sidelink resource pool configuration has a different subcarrier spacing, or different bandwidth, or different location in frequency, or any combination thereof, than the second sidelink resource pool configuration.

9. A reference signal receiving method comprising:
obtaining, at a user equipment, a sidelink resource pool configuration including configuration parameters of one or more SL OFDM resources (sidelink orthogonal frequency division multiplexing resources) including one or more SL OFDM RS resources (SL OFDM reference signal resources) each dedicated to carrying one or more sidelink reference signals;
receiving, at the user equipment, reference signal control information indicating a first resource location of at least one of the one or more SL OFDM RS resources;
decoding, at the user equipment, the reference signal control information; and
using, at the user equipment, the at least one of the one or more SL OFDM RS resources to receive a first reference signal.

10. The reference signal receiving method of claim 9, wherein decoding the reference signal control information comprises decoding the reference signal control information using first decoding information associated with the one or more SL OFDM RS resources.

11. The reference signal receiving method of claim 10, wherein the one or more SL OFDM resources include one or more SL OFDM data resources each dedicated to carrying data or communication information, the reference signal control information is second-stage control information, and wherein the reference signal receiving method further comprises:
receiving, at the user equipment, first-stage control information indicating a second resource location of the reference signal control information without indicating reference signal configuration information; and
decoding, at the user equipment, the first-stage control information.

12. The reference signal receiving method of claim 10, wherein the sidelink resource pool configuration is a first sidelink resource pool configuration, the configuration parameters of one or more SL OFDM resources are first configuration parameters, and obtaining the sidelink resource pool configuration comprises obtaining a second sidelink resource pool configuration, separate from the first sidelink resource pool configuration, including second configuration parameters of one or more SL OFDM data resources each dedicated to carrying data or communication information.

13. The reference signal receiving method of claim 12, wherein the reference signal control information is second-stage control information, and the reference signal receiving method further comprises:
receiving, at the user equipment, first-stage control information indicating a second resource location of the reference signal control information without indicating reference signal configuration information; and
decoding, at the user equipment, the first-stage control information.

14. The reference signal receiving method of claim 12, wherein the reference signal control information is second-stage control information, and the reference signal receiving method further comprises:
receiving, at the user equipment, first-stage control information indicating a second resource location of the reference signal control information and indicating reference signal configuration information; and
decoding, at the user equipment, the first-stage control information including the reference signal configuration information.

15. The reference signal receiving method of claim 12, wherein the reference signal control information is a single-stage control information message.

16. The reference signal receiving method of claim 12, wherein the first sidelink resource pool configuration has a different subcarrier spacing, or different bandwidth, or different location in frequency, or any combination thereof, than the second sidelink resource pool configuration.

17. An apparatus comprising:
a transceiver;
a memory; and
a processor, communicatively coupled to the memory and the transceiver, configured to:
obtain a sidelink resource pool configuration including first configuration parameters, of one or more SL OFDM data resources (sidelink orthogonal frequency division multiplexing data resources) each dedicated to carrying data or communication information, and second configuration parameters, of one or more SL OFDM RS resources (SL OFDM reference signal resources) each dedicated to carrying one or more sidelink reference signals; and
transmit, via the transceiver, the sidelink resource pool configuration.

18. The apparatus of claim 17, wherein the first configuration parameters and the second configuration parameters include a plurality of shared configuration parameters.

19. The apparatus of claim 18, wherein the plurality of shared configuration parameters comprise subcarrier spacing, bandwidth, frequency domain location, and time domain location.

20. The apparatus of claim 17, wherein the first configuration parameters are separate from the second configuration parameters.

21. The apparatus of claim 20, wherein the first configuration parameters include a first subcarrier spacing, a first location in frequency, and a first bandwidth, and wherein the second configuration parameters include a second subcarrier spacing, a second location in frequency, and a second bandwidth, wherein:
the second subcarrier spacing is different from the first subcarrier spacing; or
the second location in frequency is different from the first location in frequency; or
the second bandwidth is different from the first bandwidth; or
any combination thereof.

22. The apparatus of claim 17, wherein the apparatus is a first user equipment, and the processor is configured to:
encode second control information with second coding information associated with the one or more SL OFDM RS resources to produce encoded second control information;
obtain first control information indicating a resource location of the encoded second control information without indicating a reference signal configuration; and
transmit, via the transceiver, the first control information and the encoded second control information to a second user equipment.

23. The apparatus of claim 17, wherein the apparatus is a first user equipment, the first configuration parameters are separate from the second configuration parameters, and the processor is configured to:
obtain single-stage control information indicating a resource location of the one or more SL OFDM RS resources; and
transmit, via the transceiver, the single-stage control information to a second user equipment.

24. A resource pool allocation method comprising:
obtaining, at an apparatus, a sidelink resource pool configuration including first configuration parameters, of one or more SL OFDM data resources (sidelink orthogonal frequency division multiplexing data resources) each dedicated to carrying data or communication information, and second configuration parameters, of one or more SL OFDM RS resources (SL OFDM reference signal resources) each dedicated to carrying one or more sidelink reference signals; and
transmitting, from the apparatus to a user equipment, the sidelink resource pool configuration.

25. The resource pool allocation method of claim 24, wherein the first configuration parameters and the second configuration parameters include a plurality of shared configuration parameters.

26. The resource pool allocation method of claim 25, wherein the plurality of shared configuration parameters comprise subcarrier spacing, bandwidth, frequency domain location, and time domain location.

27. The resource pool allocation method of claim 24, wherein the first configuration parameters are separate from the second configuration parameters.

28. The resource pool allocation method of claim 27, wherein the first configuration parameters include a first subcarrier spacing, a first location in frequency, and a first bandwidth, and wherein the second configuration parameters include a second subcarrier spacing, a second location in frequency, and a second bandwidth, wherein:
the second subcarrier spacing is different from the first subcarrier spacing; or
the second location in frequency is different from the first location in frequency; or
the second bandwidth is different from the first bandwidth; or
any combination thereof.

29. The resource pool allocation method of claim 24, wherein the user equipment is a second user equipment and the apparatus is a first user equipment, and the resource pool allocation method further comprises:
encoding, at the first user equipment, second control information with second coding information associated with the one or more SL OFDM RS resources to produce encoded second control information;
obtaining, at the first user equipment, first control information indicating a resource location of the encoded second control information without indicating a reference signal configuration; and
transmitting, from the first user equipment to the second user equipment, the first control information and the encoded second control information.

30. The resource pool allocation method of claim 24, wherein the user equipment is a second user equipment and the apparatus is a first user equipment, the first configuration parameters are separate from the second configuration parameters, and the resource pool allocation method further comprises:
obtaining, at the first user equipment, single-stage control information indicating a resource location of the one or more SL OFDM RS resources; and
transmitting, from the first user equipment to the second user equipment, the single-stage control information.
